(19) United States
(12) Patent Application Publication
(10) Pub. No.: US 2017/0283748 A1
(43) Pub. Date: Oct. 5, 2017

(54) ENCAPSULATED CLEANING COMPOSITION

(71) Applicant: BASF SE, Ludwigshafen (DE)

(72) Inventor: Christopher C. Caires, Birmingham, MI (US)

(73) Assignee: BASF SE, Ludwigshafen (DE)

(21) Appl. No.: 15/509,141

(22) PCT Filed: Sep. 10, 2015
(86) PCT No.: PCT/US2015/049423

§ 371 Date: Mar. 6, 2017

Related U.S. Application Data
(60) Provisional application No. 62/048,559, filed on Sep. 10, 2014.
(60) Provisional application No. 62/054,078, filed on Sep. 23, 2014.

(51) Int. Cl. C11D 17/04; C11D 3/43; C11D 3/33; C11D 3/386; C11D 3/34

(52) U.S. Cl. CPC C11D 17/043; C11D 3/38618; C11D 3/38663; C11D 3/349; C11D 3/33; C11D 3/43

(57) ABSTRACT

An encapsulated cleaning composition includes a core cleaning composition and a water-soluble film disposed about the core cleaning composition. The core cleaning composition itself includes an ionic liquid, water present in an amount of from 10 to 50 parts by weight per 100 parts by weight of the core cleaning composition, and at least one of a chelant, an enzyme, and a surfactant. The water-soluble film has a disintegration time of less than 90 seconds as determined at 40° C. using distilled water according to MSTM 205, when disposed about the core cleaning composition. The water-soluble film also remains stable for 6 months at 25° C., when disposed about the core cleaning composition.

### FIELD OF THE DISCLOSURE

The disclosure generally relates to an encapsulated cleaning composition. More specifically, this disclosure relates to an encapsulated cleaning composition that includes a core cleaning composition including an ionic liquid and a water-soluble film disposed about the core cleaning composition.

### BACKGROUND

Enzymes in a liquid environment can be difficult to stabilize and are prone to decomposition and loss of activity at elevated temperatures and/or over time. Several products, such as detergents, septic tank treatments, and drain cleaners use enzymes as a key ingredient for performance and sometimes package those enzyme formulas inside a water soluble film pouch (e.g. a polyvinyl alcohol (PVA) pouch). However, when the enzyme formula is a liquid or gel, a solvent is usually required to disperse or dissolve the enzymes and other formula ingredients. Although very small amounts of water can be used to facilitate this dissolution, water is detrimental to the pouch and dissolves the pouch prematurely, thereby ruining the product. Other solvents such as glycols, short chain alcohols, and glycol ethers (e.g. propylene glycol, butylene glycol, glycerine) can also be used solvents. However, when these solvents are used, they can plasticize and deform the pouch, again ruining the product. Moreover, these solvents tend to be poor solvents for many of the formula ingredients. Accordingly, there remains an opportunity to develop an improved product.

### BRIEF DESCRIPTION OF THE FIGURES

Other advantages of the present disclosure will be readily appreciated, as the same becomes better understood by reference to the following detailed description when considered in connection with the accompanying drawings wherein:

FIG. 1 is a bar graph showing rinse efficiency of various Examples evaluated pursuant to ASTM D3556;

FIG. 2 is a bar graph showing rinse efficiency of additional Examples evaluated pursuant to ASTM D3556;

FIG. 3 is a bar graph showing rinse efficiency of various comparative Examples evaluated pursuant to ASTM D3556;

FIG. 4 is a bar graph showing enzyme stability and change in percentage of soil removal of various Examples;

FIG. 5 is a bar graph showing Disintegration of Monodose® M8630 Water-Soluble Film in Distilled Water at 25 C at 42 Days when disposed about Compositions 16-19;

FIG. 6 is a bar graph showing Disintegration of Monodose® M8310 Water-Soluble Film in Distilled Water at 25 C at 42 Days when disposed about Compositions 16-19; and

FIG. 7 is a bar graph showing Disintegration of Monodose® M8900 Water-Soluble Film in Distilled Water at 25 C at 42 Days when disposed about Compositions 16-19.

### SUMMARY OF THE DISCLOSURE

This disclosure provides an encapsulated cleaning composition that includes a core cleaning composition and a water-soluble film disposed about the core cleaning composition. The core cleaning composition itself includes an ionic liquid, water present in an amount of from 10 to 50 parts by weight per 100 parts by weight of the core cleaning composition, and at least one of a chelant, an enzyme, and a surfactant. The water-soluble film has a disintegration time of less than 90 seconds as determined at 40° C. using distilled water according to MSTM 205, when disposed about the core cleaning composition. The water-soluble film also remains stable for 6 months at 25° C., when disposed about the core cleaning composition.

### DETAILED DESCRIPTION OF THE DISCLOSURE

This disclosure provides an encapsulated cleaning composition that includes a core cleaning composition and a water-soluble film disposed about the core cleaning composition. It is to be understood that the terminology “disposed” may encompass both partial and complete covering of the core cleaning composition by the water-soluble film. The partial or complete covering of the core cleaning composition by the water-soluble film encapsulates the core cleaning composition thereby forming the encapsulated cleaning composition. In various embodiments, the core cleaning composition is encapsulated wholly or partially, e.g. by one or more layers of the water-soluble film. In various embodiments, 1, 2, 3, 4, or 5 layers of the water-soluble film are utilized. Each one of these layers may be independently disposed on and in direct contact with any one or more other layers or disposed on, and spaced apart from, any one of more layers.

### Core Cleaning Composition:

The core cleaning composition includes an ionic liquid, water present in an amount of from 10 to 50 parts by weight per 100 parts by weight of the core cleaning composition, and at least one of a chelant, an enzyme, and a surfactant. Each is described in greater detail below. In other words, the core cleaning composition can include the chelant and the enzyme, the chelant and the surfactant, the enzyme and the surfactant, the chelant without the enzyme and/or surfactant, the enzyme without the chelant and/or surfactant, or the surfactant without the enzyme and/or chelant.

In various embodiments, the core cleaning composition is, includes, consists essentially of, or consists of, the ionic liquid, the water and the chelant. In other embodiments, the core cleaning composition is, includes, consists essentially of, or consists of, the ionic liquid, the water and the enzyme. In further embodiments, the core cleaning composition is, includes, consists essentially of, or consists of, the ionic liquid, the water and the surfactant. In yet further embodiments, the core cleaning composition is, includes, consists essentially of, or consists of, the ionic liquid, the water, the chelant, the enzyme, and the surfactant. Alternatively, the core cleaning composition may be, include, consist essentially of, or consist of, the ionic liquid, the water, the chelant, the enzyme, and the surfactant. In other embodiments, the core cleaning composition further includes, further consists essentially of, or further consists of, a solvent and/or polymer, in addition to the one or more components described above. The terminology “consists essentially of” describes embodiments wherein the core cleaning composition includes the recited components but is free of other components that may directly interfere with the recited components. For example, the core cleaning composition may be free of ionic liquids, chelants, enzymes, surfactants, polymers, and/or any optional components not described herein.

### Ionic Liquid:

The ionic liquid is typically a salt that has a melting temperature of 100, 95, 90, 85, 80, 75, 70, 65, 60, 55, 50, 45, 40, 35, 30, or 25° C., or less, or, in an alternative embodiments, has a melting temperature of 60, 55, 50, or 45, ° C. or less, or, in yet other alternative embodiments, has a melting temperature of 40, 35, or 30, ° C. or less. In another embodiment, the ionic liquid is a salt that is liquid at room temperature, e.g. 25° C. In other embodiments, the ionic liquid exhibits no discernible melting point (e.g. based on DSC analysis) but is “flowable” at a temperature of 100, 95, 90, 85, 80, 75, 70, 65, 60, 55, 50, 45, 40, 35, 30, or 25, ° C. or below, or, in other embodiments, is “flowable” at a temperature of from 20° C. to 80° C., from 25° C. to 75° C., from 30° C. to 70° C., from 35° C. to 65° C., from 40° C. to 60° C., from 45° C. to 55° C., or from 50° C. to 55° C. In various embodiments, the term “flowable” and/or the term “liquid” describes that the ionic liquid exhibits a viscosity of less than 10,000, 9,000, 8,000, 7,000, 6,000, 5,000, 4,000, 3,000, 2,000, or 1,000, mPa·s at the temperatures described above. The viscosities of the ionic fluids can be measured on a Brookfield viscometer model number LVDVII+ at 20° C., with spindle no. S31 at the appropriate speed to measure materials of different viscosities. The sample can be pre-conditioned by storing the ionic liquids in a desiccator including a desiccant (e.g. calcium chloride) at room temperature for at least 48 hours prior to the viscosity measurement. This equilibration period unifies the amount of innate water in the ionic liquid samples. All values and ranges of values between and including the aforementioned values are hereby expressly contemplated in various non-limiting embodiments.

The terms “ionic liquid”, “ionic compound”, and “IL” may encompass ionic liquids, ionic liquid composites, and mixtures of ionic liquids. The ionic liquid can include an anionic IL component and a cationic IL component. When the ionic liquid is in a liquid form, these components may freely associate with one another. In one embodiment, the disclosure provides a mixture of two or more, typically at least three, different and charged IL components, wherein at least one IL component is cationic and at least one IL component is anionic. Thus, the pairing of three cationic and anionic IL components in a mixture could result in at least two different ionic liquids. The mixtures of ionic liquids may be prepared either by mixing individual ionic liquids having different IL components, or by preparing them via combinatorial chemistry. Such combinations and their preparation are described in further detail in US 2004/0077519A1 and US 2004/0097755A1, each of which is expressly incorporated herein by reference in one or more non-limiting embodiments. As used herein, the term “ionic liquid composite” typically describes a mixture of a salt (which can be solid at room temperature) with a proton donor Z (which can be a liquid or a solid) as described in the references set forth immediately above. Upon mixing, these components may turn into a liquid at 100° C. or less, and the mixture typically behaves like an ionic liquid.

In various embodiments, the ionic liquids suitable for use herein may have, or be, various anion and cation combinations. The anions and cations can be adjusted and mixed such that properties of the ionic liquids can be customized for specific applications, so as to provide the desired solvating properties, viscosity, melting point, and other properties, as desired. Non-limiting examples of ionic liquids that may be used herein are described in U.S. Pat. Nos. 6,048,388; 5,827,602; US 2003/915735A1; US 2004/0007693A1; US 2004/003120; US 2004/0035293A1; WO 02/26701; WO 03/074494; WO 03/022812; and WO 04/016570, each of which is expressly incorporated herein by reference in one or more non-limiting embodiments. In other embodiments, one or more of the following anions and cations can be utilized.

### Anions:

Alkyl sulfates (AS), alkoxy sulfates and alkyl alkoxy sulfates, wherein the alkyl or alkoxy is linear, branched or mixtures thereof can be utilized. Furthermore, the attachment of the sulfate group to the alkyl chain can be terminal on the alkyl chain (AS), internal on the alkyl chain (SAS) or mixtures thereof: non-limiting examples include linear C₁₀-C₂₀ alkyl sulfates having formula: CH₃(CH₂)_{x+y}CH₂OSO₃⁻M⁺ wherein x+y is an integer of at least 8, typically at least 10, and wherein M⁺ is a cation chosen from the cations of the ionic liquids as described in detail herein; or linear C₁₀-C₂₀ secondary alkyl sulfates having formula:

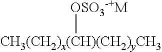

wherein x+y is an integer of at least 7, typically at least 9; x or y can be 0. Alternatively, M⁺ is a cation chosen from the cations of the ionic liquids as described in detail herein; or C₁₀-C₂₀ secondary alkyl ethoxy sulfates having formula:

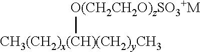

wherein x+y is an integer of at least 7, typically at least 9; x or y can be 0. Alternatively, M⁺ is a cation chosen from the cations of the ionic liquids as described in detail herein. Non-limiting examples of alkoxy sulfates include sulfated derivatives of commercially available alkoxy copolymers, such as Pluronics® (from BASF).

Mono- and di-esters of sulfosuccinates may also be used. Non-limiting examples include saturated and unsaturated C₁₂-C₁₈ monoester sulfosuccinates, such as lauryl sulfosuccinate available as Mackanate LO-100® (from The McIntyre Group); saturated and unsaturated C₆-C₁₂ diester sulfosuccinates, such as dioctyl ester sulfosuccinate available as Aerosol OT® (from Cytec Industries, Inc.). Methyl ester sulfonates (MES) can also be utilized.

Alkyl aryl sulfonates can alternatively be utilized. Non-limiting examples include tosylate, alkyl aryl sulfonates having linear or branched, saturated or unsaturated C₈-C₁₄ alkyls; alkyl benzene sulfonates (LAS) such as C₁₁-C₁₈ alkyl benzene sulfonates; sulfonates of benzene, cumene, toluene, xylene, t-butyl benzene, di-isopropyl benzene, or isopropyl benzene; naphthalene sulfonates and C₆-C₁₄ alkyl naphthalene sulfonates, such as Petro® (from Akzo Nobel Surface Chemistry); sulfonates of petroleum, such as Monalube 605® (from Uniqema).

Alkyl glycerol ether sulfonates having 8 to 22 carbon atoms in the alkyl moiety can also be utilized.

Moreover, diphenyl ether (bis-phenyl) derivatives can be used. Non-limiting examples include triclosan (2,4,4′-trichloro-2′-hydroxydiphenyl ether) and diclosan (4,4′-dichloro-2-hydroxydiphenyl ether), both are available as Irgasan® from Ciba Specialty Chemicals.

Linear or cyclic carboxylates can be used. Non-limiting examples include citrate, lactate, tartarate, succinate, alkylene succinate, maleate, gluconate, formate, cinnamate, benzoate, acetate, salicylate, phthalate, aspartate, adipate, acetyl salicylate, 3-methyl salicylate, 4-hydroxy isophthalate, dihydroxyfumarate, 1,2,4-benzene tricarboxylate, pentanoate and combinations thereof.

Alkyl oxyalkylene carboxylates can be used. Non-limiting examples include C₁₀-C₁₈ alkyl alkoxy carboxylates typically including 1-5 ethoxy units.

Alkyl diphenyl oxide monosulfonates can be used. Non-limiting examples include alkyl diphenyl oxide monosulfonate of the general formula:

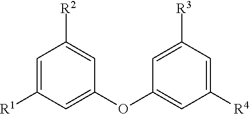

wherein R¹ is C₁₀-C₁₈ linear or branched alkyl; R² and R³ are independently SO3⁻ or H, provided at least one of R² or R³ is not hydrogen; R⁴ is R¹ or H. Suitable alkyl diphenyl oxide monosulfonates are available as DOWFAX® from Dow Chemical and as POLY-TERGENT® from Olin Corp.

Mid-chain branched alkyl sulfates (HSAS), mid-chain branched alkyl aryl sulfonates (MLAS) and mid-chain branched alkyl polyoxyalkylene sulfates can be used. Non-limiting examples of MLAS are disclosed in U.S. Pat. Nos. 6,596,680; 6,593,285; and 6,202,303, each of which is expressly incorporated herein by reference in one or more non-limiting embodiments.

Alpha olefin sulfonates (AOS) and paraffin sulfonates can also be utilized. Non-limiting examples include C₁₀-C₂₂ alpha-olefin sulfonates, available as Bio Terge AS-40® from Stepan Company.

Alkyl phosphate esters can be used. Non-limiting examples include C₈-C₂₂ alkyl phosphates, available as Emphos CS® and Emphos TS-230® from Akzo Nobel Surface Chemistry LLC.

Sarcosinates having the general formula RCON(CH₃)CH₂CO₂⁻, wherein R is an alkyl from C₈-C₂₀ can be used. Non-limiting examples include ammonium lauroyl sarcosinate, available as Hamposyl AL-30® from Dow Chemicals and sodium oleoyl sarcosinate, available as Hamposyl O® from Dow Chemical.

Taurates, such as C₈-C₂₂ alkyl taurates, available as sodium coco methyl tauride or Geropon TC® from Rhodia, Inc. can also be utilized.

Sulfated and sulfonated oils and fatty acids, linear or branched, such as those sulfates or sulfonates derived from potassium coconut oil soap available as Norfox 1101® from Norman, Fox & Co. and Potassium oleate from Chemron Corp. can also be used.

Alkyl phenol ethoxy sulfates and sulfonates, such as C₈-C₁₄ alkyl phenol ethoxy sulfates and sulfonates can be used. Non-limiting examples include sulfated nonylphenol ethoxylate available as Triton XN-45S® from Dow Chemical.

Fatty acid ester sulfonates having the formula: R¹CH(SO₃³¹)CO₂R² can also be used wherein R¹ is linear or branched C₈ to C₁₈ alkyl, and R² is linear or branched C₁ to C₆ alkyl group.

Substituted salicylanilide anions having the following formulas can also be used:

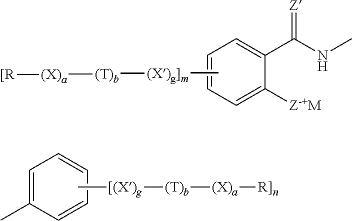

wherein m is an integer from 0 to 4; n is an integer from 0 to 5; the sum of m+n is greater than zero; a is 0 or 1; b is 0 or 1; g is 0 or 1; wherein when b is 0, one of a and g must be 0; wherein Z and Z′ are independently chosen from O and S; wherein X and X′, when present, are chosen from O, S, and NR¹, where R¹ is independently chosen from H, C₁-C₁₆ linear or branched, substituted or unsubstituted alkyl, alkenyl, alkynyl, cycloalkyl, cycloalkenyl, alkaryl, aralkyl, and aryl; wherein T, when present, is chosen from C═O, C═S, S═O, and SO₂; wherein when T is S═O or SO₂, X and X′ may not be S; wherein when either a, b or g is 1 for a radical R—(X)ₐ—(T)_{b}—(X′)_{g}—, R for that radical is independently chosen from H, C₁-C₁₆ linear or branched, substituted or unsubstituted alkyl, alkenyl, alkynyl, cycloalkyl, cycloalkenyl, alkaryl, aralkyl, and aryl; wherein when a, b and g are all 0 for a radical, R for that radical may be further chosen from F, Cl, Br, I, CN, R²NO, NO₂; wherein when all a, b and g are 0, at least one R must be non-H; further provided that the total number of halogen atoms in the molecule excluding any present in R does not exceed two; and wherein R² is independently chosen from C₁-C₁₆ linear or branched, substituted or unsubstituted alkyl, alkenyl, alkynyl, cycloalkyl, cycloalkenyl, alkaryl, aralkyl, and aryl, and mixtures thereof; derivatized substituted salicylanilide anions, wherein one or both aromatic rings include additional substituents, are also suitable for use herein. Substituted salicylanilide and derivatives thereof are disclosed in US 2002/0068014A1 and WO 04/026821, each of which is expressly incorporated herein by reference in one or more non-limiting embodiments. Moreover, M⁺ is a cation chosen from the cations of the ionic liquids as disclosed herein.

Substituted phenol or thiophenol anions having the following formula may also be used:

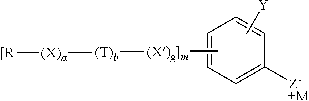

wherein m is an integer from 0 to 4; a is 0 or 1; b is 0 or 1; g is 0 or 1; wherein when b is 0, one of a and g must be 0; Z is chosen from O and S; wherein X and X′, when present, are chosen from O, S, and NR¹; wherein when either a, b or g is 1 for a radical R—(X)ₐ—(T)_{b}—(X)_{g}—, R for that radical is independently chosen from H, C₁-C₁₆ linear or branched, substituted or unsubstituted alkyl, alkenyl, alkynyl, cycloalkyl, cycloalkenyl, alkaryl, aralkyl, and aryl; wherein when a, b and g are all 0 for a radical, R for that radical may be further chosen from F, Cl, Br, I, CN, R²NO, NO₂; wherein T, when present, is chosen from C═O, C═S, S═O, and SO₂; wherein when T is S═O or SO₂, X and X′ may not be S; wherein Y is a radical including at least 1 but no more than 20 carbon atoms and including a substituent —X″—H, wherein X″ is chosen from O, S, and N—(T′)_{b′}—(X″)_{a′}—R², where a′ is 0 or 1, b′ is 0 or 1, and X′″, when present, is chosen from O, S, and NR²; R² is independently chosen from H, C₁-C₁₆ linear or branched, substituted or unsubstituted alkyl, alkenyl, alkynyl, cycloalkyl, cycloalkenyl, alkaryl, aralkyl, and aryl; wherein T′, when present, is chosen from C═O, C═S, and SO₂; wherein when T′ is SO₂′ X′″ may not be S; and wherein R³ is independently chosen from C₁-C₁₆ linear or branched, substituted or unsubstituted alkyl, alkenyl, alkynyl, cycloalkyl, cycloalkenyl, alkaryl, aralkyl, and aryl, and mixtures thereof. The substituted phenol or thiophenol anions are disclosed in US 2002/0068014A1 and WO 04/026821, each of which is expressly incorporated herein by reference in one or more non-limiting embodiments. Moreover, M⁺ is a cation chosen from the cations of the ionic liquids as disclosed herein.

Polyamino polycarboxylates can also be used. Non-limiting examples include ethylene ethylenediamine tetraacetate (EDTA), diamine tetracetates, N-hydroxy ethyl ethylene diamine triacetates, nitrilo-tri-acetates, ethylenediamine tetraproprionates, triethylene tetraamine hexacetates, diethylene triamine pentaacetates, and ethanol diglycines.

Aminopolyphosphonates can also be used such as ethylenediamine tetramethylene phosphonate and diethylene triamine pentamethylene-phosphonate.

Moreover, sweetener derived anions such as saccharinate and acesulfamate can also be used, as shown below:

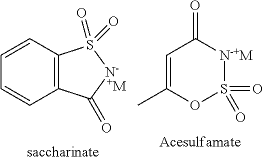

wherein M+ is a cation chosen from the cations of the ionic liquids as described herein.

In addition, ethoxylated amide sulfates; sodium tripolyphosphate (STPP); dihydrogen phosphate; fluroalkyl sulfonate; bis-(alkylsulfonyl) amine; bis-(fluoroalkylsulfonyl)amide; (fluroalkylsulfonyl)(fluoroalkylcarbonyl)amide; bis(arylsulfonyl)amide; carbonate; tetrafluorborate (BF₄⁻); hexaflurophosphate (PF₆⁻) can be used.

Moreover, anionic bleach activators having the general formula: R¹—CO—O —C₆H₄—R² can be used wherein R¹ is C₈-C₁₈ alkyl, C₈-C₁₈ amino alkyl, or mixtures thereof, and R² is sulfonate or carbonate. Non-limiting examples include:

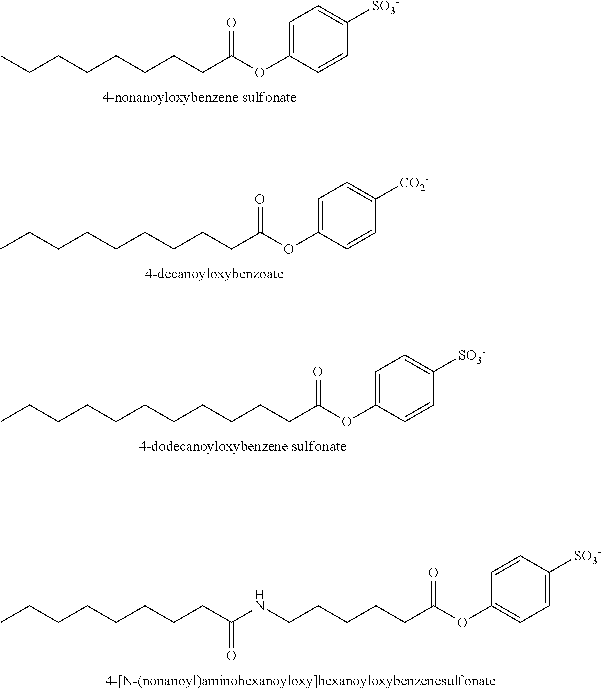

which are disclosed in U.S. Pat. Nos. 5,891,838; 6,448,430; 5,891,838; 6,159,919; 6,448,430; 5,843,879; and 6,548,467, each of which is expressly incorporated herein by reference in one or more non-limiting embodiments.

### Cations:

Cations suitable for use in the ionic liquids of the present disclosure include, but are not limited to, the following:

Cations (i.e., the protonated, cationic form) of amine oxides, phosphine oxides, or sulfoxides can be used. Non-limiting examples include amine oxide cations including one C₈-C₁₈ alkyl moiety and 2 moieties chosen from C₁-C₃ alkyl groups and C₁-C₃ hydroxyalkyl groups; phosphine oxide cations including one C₁₀-C₁₈ alkyl moiety and 2 moieties chosen from C₁-C₃ alkyl groups and C₁-C₃ hydroxyalkyl groups; and sulfoxide cations including one C₁₀-C₁₈ alkyl moiety and a moiety chosen from C₁-C₃ alkyl and C₁-C₃ hydroxyalkyl moieties. In some embodiments, the amine oxide cations have the following formula:

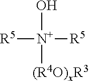

wherein R³ is an C₈-C₂₂ alkyl, C₈-C₂₂ hydroxyalkyl, C₈-C₂₂ alkyl phenyl group, and mixtures thereof; R⁴ is an C₂-C₃ alkylene or C₂-C₃ hydroxyalkylene group or mixtures thereof; x is from 0 to 3; and each R⁵ is independently an C₁-C₃ alkyl or C₁-C₃ hydroxyalkyl group or a polyethylene oxide group including an average of from 1 to 3 ethylene oxide groups. The R⁵ groups may be attached to each other, e.g., through an oxygen or nitrogen atom, to form a ring structure. Other amine oxide cations include C₁₀-C₁₈, C₁₀, C₁₀-C₁₂, and C₁₂-C₁₄ alkyl dimethyl amine oxide cations, and C₈-C₁₂ alkoxy ethyl dihydroxy ethyl amine oxide cations.

Betaines having the general formula: R—N⁽⁺⁾(R¹)₂—R²COOH can also be used wherein R is chosen from alkyl groups including from 10 to 22 carbon atoms, typically from 12 to 18 carbon atoms, alkyl aryl and aryl alkyl groups including a similar number of carbon atoms with a benzene ring treated as equivalent to 2 carbon atoms, and similar structures interrupted by amido or ether linkages, wherein each R¹ is an alkyl group including from 1 to 3 carbon atoms; and R² is an alkylene group including from 1 to 6 carbon atoms. Non-limiting examples of betaines include dodecyl dimethyl betaine, acetyl dimethyl betaine, dodecyl amidopropyl dimethyl betaine, tetradecyl dimethyl betaine, tetradecyl amidopropyl dimethyl betaine, dodecyl dimethyl ammonium hexanoate; and amidoalkylbetaines which are disclosed in U.S. Pat. Nos. 3,950,417; 4,137,191; and 4,375,421; and British Patent GB No. 2,103,236. In another embodiment, the cation may be a sulfobetaine, which are disclosed in U.S. Pat. No. 4,687,602. Each of the aforementioned documents are expressly incorporated herein by reference in one or more non-limiting embodiments.

Diester quaternary ammonium (DEQA) cations of the formula: R(₄₋ₘ)—N⁺—[(CH₂)ₙ—Y—R¹]ₘ can also be used. In this formula, each R substituent is chosen from hydrogen; C₁-C₆ alkyl or hydroxyalkyl, typically methyl, ethyl, propyl, or hydroxyethyl, and more typically methyl; poly(C₁-C₃ alkoxy), typically polyethoxy; benzyl; or a mixture thereof; m is 2 or 3; each n is from 1 to 4; each Y is —O—C(O)—,—C(O)—O—, —NR—C(O)—, or —C(O)—NR—; with the proviso that when Y is —O—C(O)—or —NR—C(O)—, the sum of carbons in each R¹ plus one is C₁₂-C₂₂, typically C₁₄-C₂₀, with each R¹ being a hydrocarbyl, or substituted hydrocarbyl group. In one embodiment, the DEQA cation is an alkyl dimethyl hydroxyethyl quaternary ammonium as described in U.S. Pat. No. 6,004,922, which is expressly incorporated herein by reference in one or more non-limiting embodiments. In another embodiment, the DEQA cation has the general formula: R₃N⁺CH₂CH(YR¹)(CH₂YR¹), wherein each Y, R, R¹ is as described above. In yet another embodiment, the DEQA cation is [CH₃]₃N⁺[CH₂CH(CH₂OC(O)R¹)OC(O)R¹] wherein each R¹ is C₁₅ to C₁₉.

Alkylene quaternary ammonium cations having the formula: R(₄₋ₘ)—N⁺—R¹ₘ can also be utilized. In this formula, each m is 2 or 3; each R is independently an alkyl or hydroxyalkyl C₁-C₆ moiety, typically methyl, ethyl, propyl or hydroxyethyl, and more typically methyl; each R¹ is independently a linear or branched, saturated or unsaturated C₆-C₂₂ alkyl or alkoxy moiety, typically C₁₄-C₂₀ moiety, but no more than one R¹ being less than C₁₂ and then the other R¹ is at least C₁₆; or hydrocarbyl or substituted hydrocarbyl moiety, typically C₁₀-C₂₀ alkyl or alkenyl, most typically C₁₂-C₁₈ alkyl or alkenyl. In one embodiment, the cation is dialkylenedimethyl ammonium, such as dioleyldimethyl ammonium available from Witco Corporation under the tradename Adogen® 472. In another embodiment, the cation is monoalkenyltrimethyl ammonium, such as monooleyltrimethyl ammonium, monocanolatrimethyl ammonium, and soyatrimethyl ammonium.

Difatty amido quaternary ammonium cations such as: [R¹—C(O)—NR—R²—N(R)₂—R³—NR—C(O)—R¹]⁺ can also be used. In this formula, R and R¹ are as described above R² and R³ are C₁-C₆ alkylene moieties.

C₈-C₂₂ quaternary surfactants such as isostearyl ethyl imidonium available in its ethosulfate salt form as Schercoquat IIS® from Scher Chemicals, Inc., quaternium-52 obtainable as Dehyquart SP® from Cognis Corporation, and dicoco dimethyl ammonium available in its chloride salt form as Arquad 2C-75® from Akzo Nobel Surface Chemistry LLC, can also be used.

Cationic esters such as those described in U.S. Pat. Nos. 4,228,042, 4,239,660, 4,260,529 and U.S. Pat. No. 6,022,844, can also be used. Each of these documents is expressly incorporated herein by reference in one or more non-limiting embodiments.

4,5-dichloro-2-n-octyl-3-isothiazolone, which is obtainable as Kathon® from Rohm and Haas can also be used. Alternatively, quaternary amino polyoxyalkylene derivatives (choline and choline derivatives) can be utilized. Moreover, alkyl oxyalkylene cations and alkoxylate quaternary ammoniums (AQA) as described in U.S. Pat. No. 6,136,769, expressly incorporated herein in one or more non-limiting embodiments, can also be used.

Substituted and unsubstituted pyrrolidinium, imidazolium, benzimidazolium, pyrazolium, benzpyrazolium, thiazolium, benzthiazolium, oxazolium, benzoxazolium, isoxazolium, isothiazolium, imdazolidenium, guanidinium, indazolium, quinuclidinium, triazolium, isoquinuclidinium, piperidinium, morpholinium, pyridazinium, pyrazinium, triazinium, azepinium, diazepinium, pyridinium, piperidonium, pyrimidinium, thiophenium; phosphonium can also be used. In one embodiment, the cation is an substituted imidazolium cation having the formula:

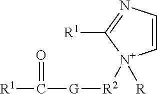

wherein each R and R¹ are as described above; each R² is a C₁-C₆ alkylene group, typically an ethylene group; and G is an oxygen atom or an —NR—group. For example, the cation 1-methyl-1-oleylamidoethyl-2-oleylimidazolinium is available commercially from the Witco Corporation under the trade name Varisoft® 3690. In another embodiment, the cation is an alkylpyridinium cation having the formula:

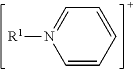

wherein R¹ is an acyclic aliphatic C₈-C₂₂ hydrocarbon group. In another embodiment, the cation is an alkanamide alkylene pyridinium cation having the formula:

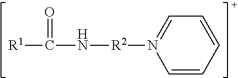

wherein R¹ is a linear or branched, saturated or unsaturated C₆-C₂₂ alkyl or alkoxy moiety, or a hydrocarbyl or substituted hydrocarbyl moiety, and R² is a C₁-C₆ alkylene moiety.

Cationic bleach activators having a quaternary ammonium moiety can also be used. These include, but are not limited to:

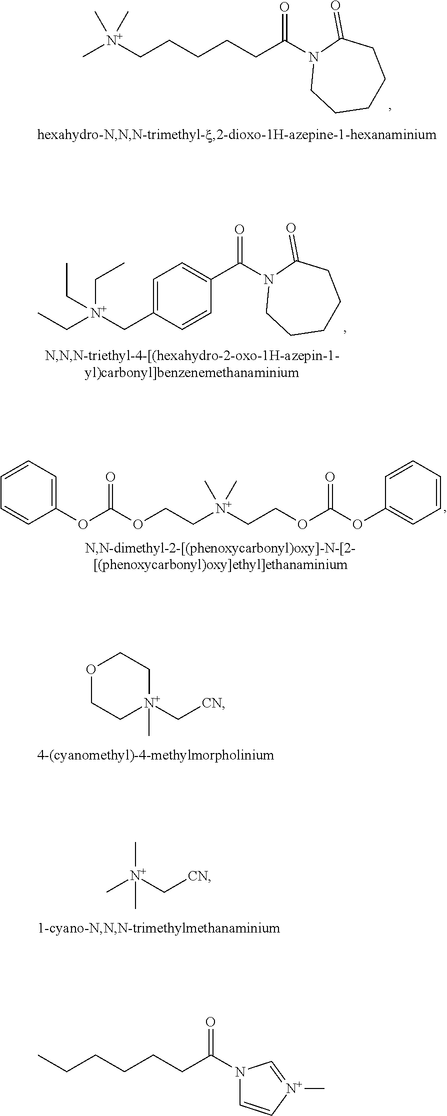

1-methyl-3-(1-oxoheptyl)-1H-Imidazolium and other cationic bleach activators suitable for use herein as cations of the ionic liquids are disclosed in U.S. Pat. Nos. 5,599,781, 5,686,015, 5,686,015, WO 95/29160, U.S. Pat. Nos. 5,599,781, 5,534,179, EP 1 253 190 A1, U.S. Pat. Nos. 6,183,665, 5,106,528, 5,281,361, and Bulletin de la Societe Chimique de France (1973), (3)(Pt. 2), 1021-7, each of which is expressly incorporated herein by reference in one or more non-limiting embodiments.

Cationic anti-microbial agents, such as cetyl pyridinium, chlorohexidine and domiphen can also be used. Moreover, alkylated caffeine cations, such as the following molecule can also be used such as:

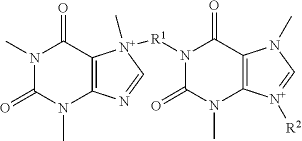

wherein R¹ and R² are C₁ to C₁₂ alkyl or alkylene groups.

In addition, alkyl poly amino carboxylates can be used such as:

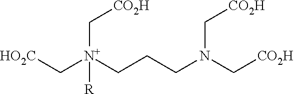

wherein R is C₈ to C₂₂ alkyl or alkylene groups or is coco, tallow or oleyl. Non-limiting examples include Ampholak® 7CX/C, Ampholak® 7TX/C, and Ampholak® XO7/C from Akzo Nobel.

In some embodiments, ionic liquids may be employed, for example including anion and cation combinations having the formulae:

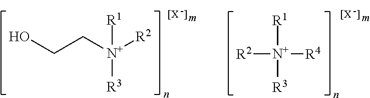

wherein R¹-R⁴ are chosen from linear or branched, substituted or unsubstituted, alkyl, aryl, alkoxyalkyl, alkylenearyl hydroxyalkyl, or haloalkyl; wherein X is an anion such as those described hereinabove; wherein m and n are chosen to provide electronic neutrality; and wherein the ionic liquids are water immiscible when at least one of R¹-R⁴ is C₁₂ or higher; or at least two of R¹-R⁴ are C₁₀ or higher; or at least three of R¹-R⁴ are C₆ or higher.

In further embodiments, the ionic liquid includes a cation chosen from trimethyloctyl ammonium cation, triisooctylmethyl ammonium cation, tetrahexyl ammonium cation, tetraoctyl ammonium cation, and mixtures thereof, and an anion chosen from those described hereinabove.

In yet further embodiments, the ionic liquids include amine oxide cations and an anion chosen from those described hereinabove. In additional embodiments, the ionic liquids include betaine cations and an anion chosen from those described hereinabove.

### Water:

The water can be any type of water, such as distilled, tap, purified, etc. The water can be present in the core cleaning composition in 10 to 50, 15 to 50, 20 to 45, 25 to 40, 30 to 35, 10 to 30, 15 to 25, or 15 to 20, parts by weight per 100 parts by weight of the cleaning composition. The water can be water that is independently added to any one or more components of the composition and/or can be water that is present in one or more of any of the components of the composition. For example, one or more components of the composition may individually have a water content of less than 10 weight percent or more than 50 weight percent but when all of the components are added together the total amount of water present in the composition may be as described above. In various embodiments, e.g. as set forth in the examples, the total amount of water in the composition may be described as total water content (from all sources). All values and ranges of values therebetween are also expressly contemplated herein in various non-limiting embodiments.

### Chelant:

Referring back to the chelant, the chelant can be any known in the art. In various non-limiting embodiments, the chelant is as described in WO2011130076, which is expressly incorporated herein by reference. The chelant may be alternatively described as a “builder.”

In various embodiments, the builder is or includes a phosphate builder and/or a phosphate free builder. Builders are typically included in an amount of from 1 to 50, 1 to 40, 5 to 50, 5 to 45, 5 to 40, 5 to 35, 5 to 30, 5 to 25, 5 to 20, 5 to 15, 5 to 10, 10 to 40, 10 to 35, 10 to 30, 10 to 25, 10 to 20, 10 to 15, 15 to 40, 15 to 35, 15 to 30, 15 to 25, 15 to 20, 20 to 40, 20 to 35, 20 to 30, or 20 to 25, weight percent based on a total weight of the core cleaning composition. All values and ranges of values therebetween are also expressly contemplated herein in various non-limiting embodiments.

Non-limiting examples of suitable phosphate builders include mono-phosphates, di-phosphates, tri-polyphosphates or oligomeric-polyphosphates, and combinations thereof. Alkali metal salts of these compounds can be used, such as sodium salts.

Non-limiting examples of non-phosphate builders include amino acid based compounds, in particular MGDA (methyl-glycine-diacetic acid), and their alkaline earth (Na, K, Li) or mixtures of the alkaline earth salts and derivatives thereof, GLDA (glutamic-N,N-diacetic acid) and their alkaline earth (Na, K, Li) or mixtures of the alkaline earth salts and derivatives thereof and mixtures of MGDA and their alkaline earth salts with GLDA and their alkaline earth (Na, K, Li) or mixtures of the alkaline earth salts. In one embodiment, GLDA (salts and derivatives thereof) or tetrasodium salt thereof are used. MGDA typically is or consists of L and D enantiomers and may be, for example, an L-Isomer with an enantiomeric excess (ee) of about 30%. Mixtures of L-and D-enantiomers of methyl glycine diacetic acid (MGDA) or its respective mono-, di or trialkali or mono-, di- or triammonium salts, may be used. In one embodiment, the MGDA is predominantly the respective L -isomer with an enantiomeric excess (ee) from 10 to 75%, or any value or range of values therebetween, including the endpoints.

Other suitable builders include those which form water-soluble hardness ion complexes (sequestering builder) such as citrates and builders which form hardness precipitates (precipitating builder) such as carbonates e.g. sodium carbonate. Alternatively, other suitable non-phosphate builders include amino acid based compounds or a succinate based compound. Other suitable builders are described in U.S. Pat. No. 6,426,229, which is expressly incorporated herein by reference in one or more non-limiting embodiments.

In one embodiment, suitable builders include; for example, aspartic acid-N-monoacetic acid (ASMA), aspartic acid-N,N-diacetic acid (ASDA), aspartic acid-N-monopropionic acid (ASMP), iminodisuccinic acid (IDA), N-(2-sulfomethyl) aspartic acid (SMAS), N-(2-sulfoethyl) aspartic acid (SEAS), N-(2-sulfomethyl) glutamic acid (SMGL), N-(2-sulfoethyl) glutamic acid (SEGL), N-methyliminodiacetic acid (MIDA), alpha-alanine-N,N-diacetic acid (alpha-ALDA), serine-N,N-diacetic acid (SEDA), isoserine-N,N-diacetic acid (ISDA), phenylalanine-N,N-diacetic acid (PHDA), anthranilic acid-N,N-diacetic acid (ANDA), sulfanilic acid-N,N-diacetic acid (SLDA), taurine-N,N-diacetic acid (TUDA) and sulfomethyl-N,N-diacetic acid (SMDA) and alkali metal salts or ammonium salts thereof.

In other embodiments, suitable non-limiting builders include homopolymers and copolymers of polycarboxylic acids and their partially or completely neutralized salts, monomeric polycarboxylic acids and hydroxycarboxylic acids and their salts. In one embodiment, salts of the abovementioned compounds include the ammonium and/or alkali metal salts, i.e. the lithium, sodium, and potassium salts, and sodium salts may be particularly useful.

Suitable non-limiting polycarboxylic acids include acyclic, alicyclic, heterocyclic and aromatic carboxylic acids, in which case they include at least two carboxyl groups which are in each case separated from one another, in one embodiment by no more than two carbon atoms. Polycarboxylates which comprise two carboxyl groups include, for example, water-soluble salts of, malonic acid, (ethyl enedioxy)diacetic acid, maleic acid, diglycolic acid, tartaric acid, tartronic acid and fumaric acid. Polycarboxylates which include three carboxyl groups include, for example, water-soluble citrate. Correspondingly, a suitable hydroxycarboxylic acid is, for example, citric acid. Other suitable polycarboxylic acids are the homopolymer of acrylic acid and/or the homopolymer of polyaspartic acid. Other suitable builders are disclosed in U.S. Pat. No. 5,698,504, which is expressly incorporated herein by reference in one or more non-limiting embodiments.

### Enzyme:

Referring back to the enzyme, the enzyme can be any known in the art. In various non-limiting embodiments, the enzyme is as described in WO2011130076, which is expressly incorporated herein by reference in one or more non-limiting embodiments. A combination of two or more enzymes can be used, such as amylases, proteases, cellulases, etc. Such a combination can contribute to an enhanced cleaning across a broader temperature and/or substrate range and provide superior shine benefits, especially when used in conjunction with a polymer. In one embodiment, the enzyme is chosen from amylases, proteases, and combinations thereof.

Suitable non-limiting proteases for use herein include metalloproteases and serine proteases, including neutral or alkaline microbial serine proteases, such as subtilisins (EC 3.4.21.62). Suitable proteases include those of animal, vegetable or microbial origin. Chemically or genetically modified mutants can be included. The protease may be a serine protease, in one embodiment, an alkaline microbial protease or a chymotrypsin or trypsin-like protease.

Non-limiting examples of neutral or alkaline proteases include:

(a) subtilisins (EC 3.4.21.62), especially those derived from Bacillus, such as Bacillus lentus, B. alkalophilus, B. subtilis, B. amyloliquefaciens, Bacillus pumilus and Bacillus gibsonii described in U.S. Pat. No. 6,312,936 B1, U.S. Pat. No. 5,679,630, U.S. Pat. No. 4,760,025, and US Pat. App. Pub. No. 2009/0170745A1, each of which is expressly incorporated herein by reference in one or more non-limiting embodiments;

(b) trypsin-like or chymotrypsin-like proteases, such as trypsin (e.g., of porcine or bovine origin), the Fusarium protease described in U.S. Pat. No. 5,288,627 and the chymotrypsin proteases derived from Cellumonas described in US Pat. App. Pub. No. 2008/0063774A1 each of which is expressly incorporated herein by reference in one or more non-limiting embodiments; and

(c) metalloproteases, especially those derived from Bacillus amyloliquefaciens described in US Pat. App. Pub. No. 2009/0263882A1 and US Pat. App. Pub. No. 2008/0293610A1, each of which is expressly incorporated herein by reference in one or more non-limiting embodiments.

Additional non-limiting examples of suitable commercially available protease enzymes include those sold under the trade names Alcalase®, Savinase®, Primase®, Durazym®, Polarzyme®, Kannase®, Liquanase®, Ovozyme®, Neutrase®, Everlase® and Esperase® by Novozymes A/S (Denmark), those sold under the tradename Maxatase®, Maxacal®, Maxapem®, Properase®, Purafect®, Purafect Prime®, Purafect Ox®, FN3®, FN4®, Excellase® and Purafect OXP® by Genencor International (now Danisco US Inc.), and those sold under the tradename Opticlean® and Optimase® by Solvay Enzymes, those available from Henkel/Kemira, namely BLAP (sequence shown in FIG. 29 of U.S. Pat. No. 5,352,604 with the following mutations S99D+S101 R+S103A+V1041+G159S, hereinafter referred to as BLAP), BLAP R (BLAP with S3T+V4I+V199M+V2051+L217D), BLAP X (BLAP with S3T+V41+V2051) and BLAP F49 (BLAP with S3T+V4I+A194P+V199M+V2051+L217D)—all from Henkel/Kemira; and KAP (Bacillus alkalophilus subtilisin with mutations A230V+S256G+S259N) from Kao. Each of the aforementioned references are expressly incorporated herein by reference in one or more non-limiting embodiments.

In one embodiment, commercial proteases chosen from the group consisting of Properase®, Purafect®, Ovozyme®, Everlase®, Savinase®, Excellase® and FN3® are employed.

Suitable non-limiting amylases for use herein include those described in US Pat. App. Pub. No. 2009/0233831 A1 and US Pat. App. Pub. No. 2009/0314286A1, each of which is expressly incorporated herein by reference in one or more non-limiting embodiments. Suitable non-limiting commercially available amylases for use herein include STAINZYME®, STAINZYME PLUS®, STAINZYME ULTRA® and NATALASE® (Novozymes A/S) and Spezyme Xtra® and Powerase®. STAINZYME PLUS® and Powerase® may be particularly useful.

Suitable non-limiting cellulases for use herein include microbial-derived endoglucanases exhibiting endo-beta-1,4-glucanase activity (E.C. 3.2.1.4), including a bacterial polypeptide endogenous to a member of the genus Bacillus which has a sequence of at least 90%, 94%, 97% and even 99% identity to the amino acid sequence SEQ ID NO:2 in U.S. Pat. No. 7,141,403B2, expressly incorporated herein by reference in one or more non-limiting embodiments, and mixtures thereof. Suitable commercially available cellulases for use herein include Celluzyme®, Celluclean®, Whitezyme® (Novozymes A/S) and Puradax HA® (Genencor International—now Danisco US Inc.).

Other enzymes suitable for use herein can be chosen from hemicellulases, cellobiose dehydrogenases, peroxidases, xylanases, lipases, phospholipases, esterases, cutinases, pectinases, mannanases, pectate lyases, keratinases, reductases, oxidases, phenoloxidases, lipoxygenases, ligninases, pullulanases, tannases, pentosanases, malanases, beta-glucanases, arabinosidases, hyaluronidase, chondroitinase, laccase, and combinations thereof. In other embodiments, the enzyme may be a lipase, including “first cycle lipases” including a substitution of an electrically neutral or negatively charged amino acid.

The core cleaning composition may also include an enzyme stabilizer such as an oligosaccharide, polysaccharide, and/or inorganic divalent metal salts, such as alkaline earth metal salts, especially calcium salts. Chlorides and sulphates may be particularly suitable. Non-limiting examples of suitable oligosaccharides and polysaccharides, such as dextrins, are described in US Pat. App. Pub. No. 2008/000420, which is expressly incorporated herein by reference in one or more non-limiting embodiments.

The enzyme may be included in an amount of from 1 to 50, 1 to 40, 5 to 50, 5 to 45, 5 to 40, 5 to 35, 5 to 30, 5 to 25, 5 to 20, 5 to 15, 5 to 10, 10 to 40, 10 to 35, 10 to 30, 10 to 25, 10 to 20, 10 to 15, 15 to 40, 15 to 35, 15 to 30, 15 to 25, 15 to 20, 20 to 40, 20 to 35, 20 to 30, 20 to 25, 1 to 5, 1 to 4, 1 to 3, 1 to 2, 1, 2, 3, 4, 5, 6, 7, 8, 9, or 10, weight percent based on a total weight of the core cleaning composition. All values and ranges of values therebetween are also expressly contemplated herein in various non-limiting embodiments.

### Surfactant:

Referring back to the surfactant, the surfactant may be any known in the art. In various embodiments, the surfactant is chosen from alcohol alkoxylates, alcohol ethoxylates, alkyl/aryl ether sulfates, alkyl/aryl sulfonates, alkyl/aryl sulfates, alkyl betaines, C₁₂-C₁₈ dialkyl quaternary ammonium salts, EO/PO block copolymers, and combinations thereof. In other embodiments, the surfactant includes or is a non-ionic surfactant. Non-ionic surfactants can also contribute to prevent redeposition of soils.

In one embodiment, the surfactant is a non-ionic surfactant or a non-ionic surfactant system, e.g. having a phase inversion temperature, as measured at a concentration of 1% in distilled water, between 40 C and 70 C. A “non-ionic surfactant system” typically is a mixture of two or more non-ionic surfactants. The phase inversion temperature is the temperature below which a surfactant, or a mixture thereof, partitions preferentially into a water phase as oil-swollen micelles and above which the surfactant partitions preferentially into an oil phase as water swollen inverted micelles. Phase inversion temperature can be determined visually by identifying at which temperature cloudiness occurs.

The phase inversion temperature of a non-ionic surfactant or system can be determined as follows: a solution including 1% of the corresponding surfactant or mixture by weight of the solution in distilled water is prepared. The solution is stirred gently before phase inversion temperature analysis to ensure that the process occurs in chemical equilibrium. The phase inversion temperature is taken in a thermostable bath by immersing the solutions in 75 mm sealed glass test tube. To ensure the absence of leakage, the test tube is weighed before and after phase inversion temperature measurement. The temperature is gradually increased at a rate of less than 1 C per minute, until the temperature reaches a few degrees below the pre-estimated phase inversion temperature. Phase inversion temperature is determined visually at the first sign of turbidity.

Non-limiting examples of suitable nonionic surfactants include: i) ethoxylated non-ionic surfactants prepared by the reaction of a monohydroxy alkanol or alkyphenol with 6 to 20 carbon atoms typically with at least 12 moles, at least 16 moles, or even at least 20 moles of ethylene oxide per mole of alcohol or alkylphenol; and ii) alcohol alkoxylated surfactants having a from 6 to 20 carbon atoms and at least one ethoxy and propoxy group. In one embodiment, mixtures of surfactants i) and ii) are particularly useful.

Another class of suitable non-ionic surfactants are epoxy-capped poly(oxyalkylated) alcohols represented by the formula: R¹O[CH₂CH(CH₃)O]ₓ[CH₂CH₂O]_{y}[CH₂CH(OH)R²] wherein R¹ is a linear or branched, aliphatic hydrocarbon radical having from 4 to 18 carbon atoms; R² is a linear or branched aliphatic hydrocarbon radical having from 2 to 26 carbon atoms; x is an integer having an average value of from 0.5 to 1.5, or 1; and y is an integer having a value of at least 15, or at least 20.

In one embodiment, the surfactant includes at least 10 carbon atoms in a terminal epoxide unit [CH₂CH(OH)R²]. Non-limiting embodiments include Olin Corporation's Poly-Tergent SLF-18B nonionic surfactants, as described, for example, in U.S. Pat. No. 5,766,371 and U.S. Pat. No. 5,576,281, each of which is expressly incorporated herein by reference in one or more non-limiting embodiments.

In various embodiments, the surfactant has a Draves wetting time of less than 360 seconds, less than 200 seconds, less than 100 seconds or less than 60 seconds as measured by the Draves wetting method (standard method ISO 8022 using the following conditions; 3-g hook, 5-g cotton skein, 0.1% by weight aqueous solution at a temperature of 25 C.).

Amine oxide surfactants can also be utilized, e.g. as anti-redeposition surfactants, and include linear and branched compounds having the formula: R³(OR⁴)ₓN⁺(O⁻)(R⁵)₂ wherein R³ is chosen from an alkyl, hydroxyalkyl, acylamidopropoyl and alkyl phenyl group, or mixtures thereof, including from 8 to 26 carbon atoms, or 8 to 18 carbon atoms; R⁴ is an alkylene or hydroxyalkylene group including from 2 to 3 carbon atoms, or 2 carbon atoms, or mixtures thereof; x is from 0 to 5, or from 0 to 3; and each R⁵ is an alkyl or hydroxyalkyl group including from 1 to 3, or from 1 to 2 carbon atoms, or a polyethylene oxide group including from 1 to 3, or even 1, ethylene oxide group. The R⁵ groups can be attached to each other, e.g., through an oxygen or nitrogen atom, to form a ring structure.

In one embodiment, the ionic liquid is tris(2-hydroxyethyl)methyl-ammonium methylsulfate. In another embodiments, the chelant is methylglycinediacetic acid. In a further embodiment, the enzyme is amylase, protease, or a combination thereof. In another embodiment, the surfactant is chosen from alcohol alkoxylates, alkyl/aryl ether sulfates, alkyl/aryl sulfonates, alkyl/aryl sulfates, alkyl betaines, C₁₂-C₁₈ dialkyl quaternary ammonium salts, ethyleneoxide/propylene oxide block copolymers, and combinations thereof. Alternatively, the solvent may be chosen from propylene glycol, ethylene glycol, butylene glycol, and mono or di ethers thereof, glyme, diglyme, triglyme, polyethylene glycol having a weight average molecular weight up to 600 g/mol, 1,3-propanediol, 1-4 butanediol, glycerine, and combinations thereof. In another embodiment, the solvent is glycerine.

### Additional Optional Components:

### Polymer:

The core cleaning composition may also include a polymer. In various embodiments, the polymer is present in an amount from 0.1 to 50, from 0.5 to 20, or from 1 to 10, percent by weight based on a total weight of the core cleaning composition.

Suitable non-limiting examples of sulfonated/carboxylated polymers may have a weight average molecular weight of less than or equal to 100,000 Da, less than or equal to 75,000 Da, less than or equal to 50,000 Da, from 3,000 Da to 50,000 Da, or from 5,000 Da to 45,000 Da. The sulfonated/carboxylated polymers may include (a) at least one structural unit derived from at least one carboxylic acid monomer having the general formula:

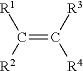

wherein R¹ to R⁴ are independently hydrogen, methyl, carboxylic acid group or CH₂COOH and wherein the carboxylic acid groups can be neutralized; (b) optionally, one or more structural units derived from at least one nonionic monomer having the general formula:

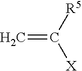

wherein R⁵ is hydrogen, C₁ to C₆ alkyl, or C₁ to C₆ hydroxyalkyl, and X is either aromatic (with R⁵ being hydrogen or methyl when X is aromatic) or X is of the general formula:

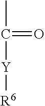

wherein R⁶ is (independently of R⁵) hydrogen, C₁ to C₆ alkyl, or C₁ to C₆ hydroxyalkyl, and Y is O or N; and at least one structural unit derived from at least one sulfonic acid monomer having the general formula: R⁷-(Aₜ)-(Bₜ)-SO³⁻wherein R⁷ is a group including at least one sp² bond, A is O, N, P, S or an amido or ester linkage, B is a mono- or polycyclic aromatic group or an aliphatic group, each t is independently 0 or 1, and M⁺ is a cation. In one embodiment, R⁷ is a C₂ to C₆ alkene. In another embodiment, R⁷ is ethene, butene or propene.

Suitable non-limiting carboxylic acid monomers include one or more of the following: acrylic acid, maleic acid, itaconic acid, methacrylic acid, or ethoxylate esters of acrylic acids, acrylic and methacrylic acids being more preferred. In one embodiment, sulfonated monomers include one or more of the following: sodium (meth)allyl sulfonate, vinyl sulfonate, sodium phenyl(meth)allyl ether sulfonate, or 2-acrylamido-methyl propane sulfonic acid. In another embodiment, non-ionic monomers include one or more of the following: methyl(meth)acrylate, ethyl(meth)acrylate, t-butyl(meth)acrylate, methyl(meth)acrylamide, ethyl(meth) acrylamide, t-butyl(meth)acrylamide, styrene, or alpha-methyl styrene.

In a further embodiment, the polymer includes from 40 to 90 or from 60 to 90, weight percent of one or more carboxylic acid monomer; from 5 to 50 or from 10 to 40, weight percent of one or more sulfonic acid monomers; and optionally from 1 to 30 or from 2 to 20, weight percent of one or more non-ionic monomers. In another embodiment, the polymer includes 70 to 80 weight percent of at least one carboxylic acid monomer and from 20 to 30 weight percent of at least one sulfonic acid monomer.

The carboxylic acid may be (meth)acrylic acid. The sulfonic acid monomer is typically one of the following: 2-acrylamido methyl-1-propanesulfonic acid, 2-methacrylamido-2-methyl-1-propanesulfonic acid, 3-methacrylamido-2-hydroxypropanesulfonic acid, allylsulfonic acid, methallylsulfonic acid, allyloxybenzenesulfonic acid, methallyloxybenzensulfonic acid, 2-hydroxy-3-(2-propenyloxy)propanesulfonic acid, 2-methyl-2-propene-1-sulfonic acid, styrene sulfonic acid, vinylsulfonic acid, 3-sulfopropyl acrylate, 3-sulfopropyl methacrylate, sulfomethylacrylamid, sulfomethylmethacrylamide, and water soluble salts thereof. The unsaturated sulfonic acid monomer is, in one embodiment, 2-acrylamido-2-propanesulfonic acid (AMPS).

Commercially available polymers include: Alcosperse 240, Aquatreat AR 540 and Aquatreat MPS commercially available from Alco Chemical; Acumer 3100, Acumer 2000, Acusol 587G and Acusol 588G commercially available from Rohm & Haas; Goodrich K-798, K-775 and K-797 commercially available from BF Goodrich; and ACP 1042 commercially available from ISP technologies Inc. Particularly suitable polymers are Acusol 587G and Acusol 588G commercially available from Rohm & Haas.

All or some of the carboxylic or sulfonic acid groups can be present in neutralized form, i.e. the acidic hydrogen atom of the carboxylic and/or sulfonic acid group in some or all acid groups can be replaced with metal ions, for example alkali metal ions and in particular sodium ions.

The surfactant may be included in an amount of from 1 to 90, 1 to 80, 5 to 50, 5 to 45, 5 to 40, 5 to 35, 5 to 30, 5 to 25, 5 to 20, 5 to 15, 5 to 10, 10 to 40, 10 to 35, 10 to 30, 10 to 25, 10 to 20, 10 to 15, 15 to 40, 15 to 35, 15 to 30, 15 to 25, 15 to 20, 20 to 40, 20 to 35, 20 to 30, 20 to 25, 1 to 5, 1 to 4, 1 to 3, 1 to 2, 1, 2, 3, 4, 5, 6, 7, 8, 9, or 10, weight percent based on a total weight of the core cleaning composition. All values and ranges of values therebetween are also expressly contemplated herein in various non-limiting embodiments.

### Drying Aids:

The core cleaning composition may also include a drying aid. Drying aids are typically compounds capable of decreasing an amount of water left on washed items, in particular in plastic items that are more prone to be wet after the washing process due to their hydrophobic nature.

Suitable non-limiting examples of drying aids include polyesters, such as anionic polyesters derived from terephthalic acid, 5-sulphoisophthalic acid or a salt of 5-sulphoisophthalic, ethyleneglycol or polyethyleneglycol, propyleneglycol or polypropyleneglycol, and, polyalkyleneglycol monoalkylethers, optionally together with further monomers with 3 to 6 functionalities which are conducive to polycondensation, specifically acid, alcohol or ester functionalities. Suitable polyesters to use as drying aids are disclosed in WO 2008/110816 and may have one or more of the following properties: (a) a number average molecular weight of from 800 Da to 25,000 Da, or from 1,200 Da to 12,000 Da; (b) a softening point greater than 40 C; from 41 C to 200 C, or 80 C to 150 C; (c) a solubility greater than 6% by weight in water of 3 German hardness at 200 C. At 30 C the solubility can be greater than 8% by weight, at 40 C. At 50 C, the solubility can be greater than 40% by as measured in water of 3 German hardness. Other suitable drying aids include specific polycarbonate-, polyurethane- and/or polyurea-polyorganosiloxane compounds or precursor compounds thereof of the reactive cyclic carbonate and urea type, as described in US 2010/0041574 A1 and US 2010/0022427 A1, each of which is expressly incorporated herein by reference in one or more non-limiting embodiments.

Improved drying can also be achieved by use of non-ionic surfactants, such as: (a) R¹O[CH₂CH(CH₃)O]ₓ[CH₂CH₂O]_{y}[CH₂CH(CH₃)]_{z}CH₂CH(OH)R², in which R¹ represents a linear or branched aliphatic hydrocarbon radical having 4 to 22 carbon atoms or mixtures thereof and R² represents a linear or branched hydrocarbon radical having 2 to 26 carbon atoms or mixtures thereof, x and z represent integers from 0 to 40, and y represents a integer of at least 15, or from 15 to 50; or (b) RO[CHCH(Rₐ)O]₁[CH₂CH₂O]ₘ[CH₂CH(R¹)O]ₙC(O)R² where R is a branched or unbranched alkyl radical having 8 to 16 carbon atoms, Rₐ and R¹ independently of one another, are hydrogen or a branched or unbranched alkyl radical having 1 to 5 carbon atoms, R² is an unbranched alkyl radical having 5 to 17 carbon atoms; 1 and n are independently of one another, an integer from 1 to 5 and m is an integer from 13 to 35. Examples of suitable materials include Plurafac LF731 or Plurafac LF-7319 (BASF) and the Dehyquart CSP and Polyquart range (Cognis).

In various embodiments, these non-ionic surfactants are used in combination with one or more of: (a) a sulphonated polymer; or (b) alkoxylated alcohols, particularly alkyl ethoxylates wherein the alkyl chain has from 8 to 14 carbon atoms, with an average of from 4 to 10, or from 6 to 8 ethoxylates, such as Lutensol TO7 commercially available from BASF.

In various embodiments, the core cleaning composition includes the drying aid in an amount of from 0.1% to 10%, from 0.5% to 5% or from 1% to 4% by weight of the core cleaning composition. All values and ranges of values therebetween are also expressly contemplated herein in various non-limiting embodiments.

### Silicates:

The core cleaning composition may also include silicate. Suitable silicates are sodium silicates such as sodium disilicate, sodium metasilicate and crystalline phyllosilicates. Silicates can be present in an amount of from 1% to 20%, or from 5% to 15% by weight of the core cleaning composition. All values and ranges of values therebetween are also expressly contemplated herein in various non-limiting embodiments.

### Bleach:

The core cleaning composition may also include a bleach. Inorganic and organic bleaches are suitable cleaning actives for use herein. Inorganic bleaches include perhydrate salts such as perborate, percarbonate, perphosphate, persulfate and persilicate salts. The inorganic perhydrate salts are normally the alkali metal salts. The inorganic perhydrate salt may be included as the crystalline solid without additional protection. Alternatively, the salt can be coated.

Alkali metal percarbonates, particularly sodium percarbonate can be utilized. The percarbonate is most typically incorporated into the products in a coated form which provides in-product stability. A suitable coating material providing in product stability includes mixed salt of a water-soluble alkali metal sulphate and carbonate. The weight ratio of the mixed salt coating material to percarbonate is typically from 1:200 to 1:4, from 1:99 to 19, or from 1:49 to 1:19. In one embodiment, the mixed salt is of sodium sulphate and sodium carbonate which has the general formula (Na₂SO₄)ₙNa₂CO₃ wherein n is from 0.1 to 3, from 0.2 to 1.0 or from 0.2 to 0.5.

Sodium silicate of SiO₂:Na₂O ratio from 1.8:1 to 3.0:1, or L8:1 to 2.4:1, and/or sodium metasilicate, in one embodiment, are applied at a level of from 2% to 10%, (normally from 3% to 5%) of SiO₂ by weight of the inorganic perhydrate salt. All values and ranges of values therebetween are also expressly contemplated herein in various non-limiting embodiments. Magnesium silicate can also be included in the coating. Compounds that include silicate and borate salts or boric acids or other inorganics are also suitable.

Waxes, oils, fatty soaps, and salts can also be used such as potassium peroxymonopersulfate. Typical organic bleaches are organic peroxyacids including diacyl and tetraacylperoxides, especially diperoxydodecanedioc acid, diperoxytetradecanedioc acid, and diperoxyhexadecanedioc acid. Dibenzoyl peroxide is a typical organic peroxyacid herein. Mono- and diperazelaic acid, mono- and diperbrassylic acid, and phthaloylaminoperoxicaproic acid are also suitable herein.

The diacyl peroxide, especially dibenzoyl peroxide, can be present in the form of particles having a weight average diameter of from 0.1 to 100 microns, from 0.5 to 30 microns, or from 1 to 10 microns. In one embodiment, at least 25%, at least 50%, at least 75%, or at least 90%, of the particles are smaller than 10 microns, or smaller than 6 microns. Diacyl peroxides within the above particle size range can provide better stain removal especially from plastic dishware, while minimizing undesirable deposition and filming during use, than larger diacyl peroxide particles.

Further examples of suitable organic bleaches include the peroxy acids, particular examples being the alkylperoxy acids and the arylperoxy acids. Typical examples include (a) peroxybenzoic acid and its ring-substituted derivatives, such as alkylperoxybenzoic acids, and also peroxy-.alpha.-naphthoic acid and magnesium monoperphthalate, (b) aliphatic or substituted aliphatic peroxy acids, such as peroxylauric acid, peroxystearic acid, epsilon-phthalimidoperoxycaproic acid [phthaloiminoperoxyhexanoic acid (PAP)], o-carboxybenzamidoperoxycaproic acid, N-nonenylamidoperadipic acid and N-nonenylamidopersuccinates, and (c) aliphatic and araliphatic peroxydicarboxylic acids, such as 1,12-diperoxycarboxylic acid, 1,9-diperoxyazelaic acid, diperoxysebacic acid, diperoxybrassylic acid, the diperoxyphthalic acids, 2-decyldiperoxybutane-1,4-dioic acid, N,N-terephthaloyldi(6-aminopercaproic acid).

### Bleach Activators:

The core cleaning composition may also include a bleach activator. Bleach activators are typically organic peracid precursors that enhance the bleaching action in the course of cleaning at temperatures of 60 C. and below. Bleach activators suitable for use herein include compounds which, under perhydrolysis conditions, give aliphatic peroxoycarboxylic acids having from 1 to 10 carbon atoms, in particular from 2 to 4 carbon atoms, and/or optionally substituted perbenzoic acid. Suitable compounds include O-acyl and/or N-acyl groups of the number of carbon atoms specified and/or optionally substituted benzoyl groups. In various embodiments, preference is given to polyacylated alkylenediamines, in particular tetraacetylethylenediamine (TAED), acylated triazine derivatives, in particular 1,5-diacetyl-2,4-dioxohexahydro-1,3,5-triazine (DADHT), acylated glycolurils, in particular tetraacetylglycoluril (TAGU), N-acylimides, in particular N-nonanoylsuccinimide (NOSI), acylated phenolsulfonates, in particular n-nonanoyl- or isononanoyloxybenzenesulfonate (n- or iso-NOBS), carboxylic anhydrides, in particular phthalic anhydride, acylated polyhydric alcohols, in particular triacetin, ethylene glycol diacetate and 2,5-diacetoxy-2,5-dihydrofuran and also triethylacetyl citrate (TEAC). Bleach activators can be utilized in an amount of from 0.1% to 10%, or from 0.5% to 2% by weight of the total core cleaning composition. All values and ranges of values therebetween are also expressly contemplated herein in various non-limiting embodiments.

### Bleach Catalyst:

The core cleaning composition may also include a bleach catalyst. Suitable bleach catalysts include the manganese triazacyclononane), Co, Cu, Mn and Fe bispyridylamine and related complexes, and pentamine acetate cobalt(III) and related complexes. In various embodiments, the bleach catalyst is utilized in an amount from 0.1 to 10, or from 0.5 to 2, percent by weight based on a total weight of the core cleaning composition. All values and ranges of values therebetween are also expressly contemplated herein in various non-limiting embodiments.

### Metal Care Agents:

The core cleaning composition may also include a metal care agent. Metal care agents may prevent or reduce the tarnishing, corrosion or oxidation of metals, including aluminum, stainless steel and non-ferrous metals, such as silver and copper. Suitable examples include one or more of the following: (a) benzatriazoles, including benzotriazole or bis-benzotriazole and substituted derivatives thereof such as compounds in which the available substitution sites on the aromatic ring are partially or completely substitute, e.g. linear or branch-chain C₁-C₂₀ alkyl groups and hydroxyl, thio, phenyl or halogen such as fluorine, chlorine, bromine and iodine; (b) metal salts and complexes chosen from zinc, manganese, titanium, zirconium, hafnium, vanadium, cobalt, gallium and cerium salts and/or complexes, e.g. Mn(II) sulphate, Mn(II) citrate, Mn(II) stearate, Mn(II) acetylacetonate, K₂TiF₆, K₂ZrF₆, CoSO₄, Co(NO₃)₂ and Ce(NO₃)₃, zinc salts, for example zinc sulphate, hydrozincite or zinc acetate; and (c) silicates, including sodium or potassium silicate, sodium disilicate, sodium metasilicate, crystalline phyllosilicate and mixtures thereof. In various embodiments, the metal care agent is utilized in an amount from 0.1 to 5, from 0.2 to 4, or from 0.3 to 3, percent by weight based on a total weight of the core cleaning composition. All values and ranges of values therebetween are also expressly contemplated herein in various non-limiting embodiments.

### Additional Embodiments:

In one additional embodiment, the composition includes water and an ionic liquid (e.g. Tris(2-hydroxyethyl)methylammonium methylsulfate commercially available from BASF under the tradename Basionics™ FS 01.). In related additional embodiments, the composition optionally includes one or more solvents (e.g. glycerin), one or more chelants (e.g. Trilon M Liquid which is commercially available from BASF and is an aqueous solution of the trisodium salt of methylglycinediacetic acid (Na₃MGDA), one or more polymers (e.g. Sokalan PA 25 CL PN which is commercially available from BASF and is a low molecular weight polyacrylic acid, partially neutralized as a sodium salt, one, two, or more enzymes (e.g., a liquid protease commercially available from Novozymes under the tradename Savinase Ultra 16 L and a liquid amylase commercially available from Novozymes under the tradename Stainzyme Plus 12L) and one or more polymer additives (e.g. polyquaternium-95). In a similar additional embodiment, the water is present in an amount of 15 wt % (and may be included in the total weight percent of one or more of the following components), the ionic liquid is present in an amount of 55 wt %, the solvent is present in an amount of 20 wt %, the chelant is present in an amount of 17 wt %, the polymer is present in an amount of 5 wt %, the two enzymes are present in a total amount of about 1.3 wt % (e.g. 1 and 0.3 wt % individually), and the polymer additive is present in an amount of 1.5 wt %, based on a total weight of the composition. In other similar additional embodiments, one or more of the aforementioned values may vary±0.1, 0.5. 1, 2, 3, 4, 5, 6, 7, 8, 9, or 10, %.

### Water Soluble Film:

The encapsulated cleaning composition also includes the water soluble film disposed about the core cleaning composition. The terminology “water soluble” film describes a film having a disintegration time of less than 90, 85, 80, 75, 70, 65, 60, 55, 50, 45, 40, 35, or 30, seconds as determined at 40° C. using distilled water according to MSTM 205 when disposed about the core cleaning composition or when measured independently from the core cleaning composition. In other embodiments, this disintegration time is evaluated at 35° C., 30° C., 25° C., 20° C., 15° C., 10° C., or 5° C., and may be any of the above values or ranges thereof. In various additional embodiments, the water soluble film described above has a complete solubility time of less than 135, 130, 125, 120, 115, 110, 105, 100, 95, 90, 85, 80, 75, 70, 65, 60, 55, 50, 45, 40, 35, or 30, seconds as determined at 40° C., 35° C., 30° C., 25° C., 20° C., 15° C., 10° C., or 5° C., using distilled water according to MSTM 205 when disposed about the core cleaning composition or when measured independently from the core cleaning composition.

In various embodiments, the water-soluble film may have one or more of the following physical properties or physical properties not set forth below. All values and ranges of values between and including all of the following ranges are hereby expressly contemplated in various non-limiting embodiments. All of the following values are in seconds and can be applied to embodiments that include zero exposure to the conditions described below, exposure for 14 days, exposure for 28 days, and/or exposure for 42 days. The standard deviation for the following values is typically 0, 1, 2, 3, 4, 5, 6, 7, 8, 9, or 10, seconds.

| “Complete Solubility” Time | | | “Disintegration” Time | | |
|---|---|---|---|---|---|
| in Distilled Water at 25 C. When Pre- | | | in Distilled Water at 25 C. When Pre- | | |
| Exposed to Various Conditions | | | Exposed to Various Conditions | | |
| as Determined using MSTM 205 | | | as Determined using MSTM 205 | | |
| Ambient | 38 C./ | 38 C./ | Ambient | 38 C./ | 38 C./ |
| Temp/Humid | 80% RH | 10% RH | Temp/Humid | 80% RH | 10% RH |
| 32-42 sec. | 32-67 sec. | 32-57 sec. | 14-16 sec. | 14-28 sec. | 14-25 sec. |
| 49-52 sec. | 50-63 sec. | 50-62 sec. | 21-23 sec. | 23-27 sec. | 23-26 sec. |
| 29-31 sec. | 29-37 sec. | 29-34 sec. | 13-15 sec. | 15-17 sec. | 15-16 sec. |
| 32-60 sec. | 32-138 sec. | 32-111 sec. | 14-19 sec. | 14-33 sec. | 14-30 sec. |
| 49-56 sec. | 50-62 sec. | 50-59 sec. | 22-23 sec. | 22-24 sec. | 23-25 sec. |
| 29-33 sec. | 29-33 sec. | 29-34 sec. | 14-15 sec. | 14-15 sec. | 14-15 sec. |
| 32-42 sec. | 32-68 sec. | 32-64 sec. | 14-17 sec. | 14-24 sec. | 14-25 sec. |
| 46-53 sec. | 50-53 sec. | 50-59 sec. | 22-23 sec. | 23-25 sec. | 23-26 sec. |
| 29-35 sec. | 29-36 sec. | 29-37 sec. | 14-15 sec. | 15-17 sec. | 15-16 sec. |
| 32-41 sec. | 32-62 sec. | 32-58 sec. | 14-15 sec. | 14-24 sec. | 14-21 sec. |
| 45-50 sec. | 50-55 sec. | 50-51 sec. | 20-23 sec. | 21-24 sec. | 22-23 sec. |
| 29-31 sec. | 29-33 sec. | 29-31 sec. | 13-15 sec. | 13-15 sec. | 14-15 sec. |

Ambient Temperature and Humidity is about 22 C and about 40% RH.

The encapsulated cleaning composition also includes the water soluble film disposed about the core cleaning composition. The terminology “water soluble” film typically describes a film having a disintegration time of less than 90, 85, 80, 75, 70, 65, 60, 55, 50, 45, 40, 35, or 30, seconds as determined at 40° C., 35° C., 30° C., 25° C., 20° C., 15° C., 10° C., or 5° C., using distilled water according to MSTM 205 when disposed about the core cleaning composition. All values and ranges of values between and including the aforementioned values are hereby expressly contemplated in various non-limiting embodiments.

The following test procedure, referred to herein as MSTM 205, is used to determine the time required for a water-soluble film to break apart (disintegrate) and its subsequent relative dissolution time when held stationary. Additionally, reference can be made to U.S. Pat. No. 6,821,590, and the figures thereof, which is expressly incorporated herein by reference relative to this test method, in various non-limiting embodiments.

### Apparatus and Materials:

A 600 mL Beaker

A magnetic stirrer 14 (Labline Model No. 1250 or equivalent)

A magnetic stirring rod 16 (5 cm)

A thermometer (0 to 100 C,±1 C)

A template, stainless steel (3.8 cm×3.2 cm)

A timer, (0-300 seconds, accurate to the nearest second)

A Polaroid 35 mm slide mount (or equivalent)

A MonoSol 35 mm slide mount holder (or equivalent)

Distilled water

Test Specimen:

1. Cut three test specimens from a sample using the stainless steel template (i.e., 3.8 cm×3.2 cm specimen). If cut from a film web, specimens should be cut from areas evenly spaced along the transverse direction of the web.

2. Lock each specimen in a separate 35 mm slide mount.

3. Fill the beaker with 500 mL of distilled water. Measure the water temperature with the thermometer and, if necessary, heat or cool the water to maintain temperature at 20 C. (about 68 F.).

4. Mark the height of the column of water. Place a magnetic stirrer on the base of the holder. Place the beaker on magnetic stirrer, add the magnetic stirring rod to beaker, turn on the stirrer, and adjust the stir speed until a vortex develops which is approximately one-fifth the height of the water column. Mark the depth of vortex.

5. Secure the 35 mm slide mount in an alligator clamp of the slide mount holder such that a long end of the slide mount is parallel to the water surface. A depth adjuster of the holder should be set so that when dropped, the end of the clamp will be about 0.6 cm below the surface of the water. One of the short sides of the slide mount should be disposed next to the side of the beaker with the other positioned directly over the center of the stirring rod such that the film surface is perpendicular to the flow of the water.

6. In one motion, drop the secured slide and clamp into the water and start the timer. Disintegration occurs when the film breaks apart. When all visible film is released from the slide mount, raise the slide out of the water while continuing to monitor the solution for undissolved film fragments. Dissolution occurs when all film fragments are no longer visible and the solution becomes clear.

Data Recording:

The results can include the following:

complete sample identification;

individual and average disintegration and dissolution times; and

water temperature at which the samples were tested.

Standard quality control procedures may be followed with respect to bubble and pin-hole inspection. However, such quality checks may not be necessary.

It is contemplated that the water-soluble film may have different disintegration properties and/or complete solubility properties if measured independently when not disposed about the core cleaning composition. The water-soluble film may or may have the aforementioned disintegration time when not disposed about the core cleaning composition and when evaluated independently from the core cleaning composition.

The water-soluble film may remain stable for or at 6 months at 25° C. when disposed about the core cleaning composition under varying temperatures and humidity conditions, e.g. after exposure to varying temperatures of from 22° C. to 38° C. and 10% to 80% relative humidity over a varying number of days, e.g. up to 6 months. In other words, the water-soluble film may remain intact after such a time period. In various embodiments, the water-soluble film is stable after exposure to 38° C. and 80% relative humidity for 14, 28, and/or 42 days. In other embodiments, the water-soluble film is stable after exposure to 38° C. and 10% relative humidity for 14, 28, and/or 42 days. In still other embodiments, the water-soluble film is stable after exposure to ambient temperature and (relative) humidity, as understood by those of skill in the art, for 14, 28, and/or 42 days. In various embodiments, ambient temperature is 22° C., 23° C., 24° C., or 25, ° C. and ambient (relative) humidity is 30%, 35%, 40%, 45%, or 50%. All values and ranges of values between and including the aforementioned values are hereby expressly contemplated in various non-limiting embodiments.

The terminology “stable” describes that the water-soluble film does not dissolve via contact with the water or any other components in the core cleaning composition. Stability can be equated to non-leakage of the core cleaning composition (e.g. the film remains intact for the specified amount of time). The stability/dissolution of the film can be evaluated visually, typically in accordance with MSTM 205, as described above. This visual evaluation can also be made by examining the film for leakage using a tissue paper to blot the film and look for wet spots, as well as manipulating the film to look for significant deformation, swelling, or brittleness, (e.g. that could cause immediately failure upon exposure to water, such as in an automatic dishwasher), as would be understood by one of skill in the art. Typically, dissolution is affirmed if/when there is leakage of the core cleaning composition through or out of the film. For example, dissolution can be affirmed when there is partial leakage and not necessarily only upon total lyses of the film. Alternatively, dissolution may be affirmed when there is total dissolution of the film and/or lyses of the film and/or extensive leakage of the encapsulated cleaning composition. Still further, dissolution may be affirmed if there is enough significant deformation, swelling, or brittleness of the encapsulated cleaning composition such that the water-soluble film would be considered to be structurally compromised, could not be used, and/or could not function commercially, as would be understood by those of skill in the art. If no dissolution is affirmed/present prior to placement of the encapsulated cleaning composition in water, then a person of skill in the art can affirm that the encapsulated cleaning composition is stable. It is contemplated that the water-soluble film may have different stability/dissolution properties if measured independently when not disposed about the core cleaning composition.

In other embodiments, the water-soluble film may have an elongation as set forth below or may have a different elongation. All values and ranges of values between and including all of the following ranges are hereby expressly contemplated in various non-limiting embodiments. Typically, elongation is measured using ISO 527-4, or its equivalent, as appreciated by those of skill in the art. The standard deviation for the following values is typically 0, 1, 2, or 3, units. The values below are elongation at break (%).

Elongation When Pre-Exposed to Various Conditions

| Ambient | 23 C./ | 38 C./ | 38 C./ |
|---|---|---|---|
| Temp/Humid | 50% RH | 80% RH | 10% RH |
| 572/25 | 814/15 | 739/103 | 745/23 |
| 537/40 | 759/20 | 699/49 | 736/15 |
| 447/13 | 761/26 | 703/32 | 648/15 |
| 572/25 | 704/13 | 706/37 | 733/37 |
| 537/40 | 656/12 | 670/20 | 680/10 |
| 447/13 | 620/8 | 623/20 | 636/8 |
| 572/25 | 536/10 | 462/29 | 456/9 |
| 537/40 | 519/7 | 441/7 | 419/34 |
| 447/13 | 409/30 | 195/58 | 305/51 |
| 572/25 | 550/63 | 520/41 | 581/14 |
| 537/40 | 492/67 | 497/32 | 486/23 |
| 447/13 | 455/16 | 441/46 | 449/55 |

The water soluble film may be, include, consist essentially of, or consist of, any water soluble compound or polymer that meets the aforementioned criteria of disintegration and stability times. For example, such compounds or polymers could be polyvinyl alcohol (PVA or PVOH), polyvinyl acetate, polyvinyl acetate that is 88-98% hydrolyzed, gelatin, and combinations thereof. Alternatively, the water-soluble film may be as described in U.S. Pat. No. 4,765,916 or U.S. Pat. No. 4,972,017, each of which is expressly incorporated herein by reference in one or more non-limiting embodiments. In various embodiments, the water-soluble film is thermoplastic.

The water soluble film may be further defined as a water soluble pouch and may be formed from, comprise, consist of, be, or consist essentially of any one or more of the aforementioned compounds. The water soluble pouch may be a single chamber, a dual chamber, or a multi-chamber pouch wherein the core cleaning composition may be disposed in one or more of the chambers. Alternatively, any one or more of the aforementioned components may be disposed in one or more of the chambers. For example, in one embodiment, two different chambers include two different cleaning agents. The two chambers could have the same or different dissolution profiles allowing the release of the same or different agents at different times. For example, the agent from a first chamber could be delivered at a first time to help with soil removal and a second agent could be delivered at a second time for a different reason.

The water soluble pouch and/or film may be, include, consist of, or consist essentially of polyvinyl alcohol, such as the type commercially available from Monosol under the trade names of M8630, M8310, and/or M8900. For example, the compositions can be independently encapsulated in Monosol (water-soluble) PVA pouches M8630, M8310, and/or M8900 which are various types of water-soluble films, to evaluate whether the pouches are stable over time. In other words, the pouches can be disposed about the core cleaning compositions. In other embodiments, the following Monosol products may be utilized alone or in combination with each other or with any of the aforementioned polymers: A127, A200, L330, L336, L336 Blue, L711, L711 Blue, M1030, M1030, M2000, M2631A, M3030, M6030, M7030, M7031, M7061, M8310, M8440, M8534, M8630, M8900, and/or M9500.

The water-soluble film and/or pouch may be a single layer, two layers, three layers, four layers, five layers, or more than five layers of any one or more of the aforementioned polymers. In various embodiments, each layer or the total combination of layers may have a thickness of from 5 to 200, 5 to 100, 10 to 95, 15 to 90, 20 to 85, 25 to 80, 30 to 75, 35 to 70, 40 to 65, 45 to 60, 50 to 55, microns. In still other embodiments, each layer or the total combination of layers has a thickness of 20, 22, 30, 32, 35, 38, 50, 76, or 90, microns,±1, 2, 3, 4, or 5, microns. All values and ranges of values between and including the aforementioned values are hereby expressly contemplated in various non-limiting embodiments.

This disclosure also provides a method of forming the encapsulated cleaning composition. In various embodiments, the method includes the steps of providing the core cleaning composition and disposing the water-soluble film about the core cleaning composition. The step of providing may be any known in the art. Any one or more of the components of the composition may be combined with any one or more other components of the core composition. Moreover, the step of disposing may also be any known in the art. For example, the step of disposing may include pouring, inserting, injecting, or otherwise placing the core cleaning composition, or any one more components thereof, into water-soluble film, e.g. into a pouch of the water-soluble film.

This disclosure also provides a dosing element for use in an auto-dosing device wherein the auto-dosing device is placed into a washing machine, e.g. a dishwasher, and holds a plurality of the encapsulated core compositions to be delivered in different washes.

### EXAMPLES

A series of Core Cleaning Compositions (Compositions 1-19) are formed as set forth below. Some are representative of this disclosure and some are comparative.

### Rinse Efficiency:

Each of the evaluations set forth below relative to rinse efficiency are of the compositions alone, without the pouches. Those of skill in the art will appreciate that, for purposes of these evaluations, the pouches are not considered to have any effect on rinse efficiency, etc.

Some of the Compositions and the Comparative Compositions are evaluated to determine Rinse Efficiency. Rinse efficiency is evaluated according to ASTM D3556 with a modification of using hard water with the following mineral content:

| Chemical | g/100 L |
|---|---|
| CaCl2•2H2O | 41.45 |
| MgSO4•7H2O | 21.30 |
| NaHCO3 | 25.21 |
| Na2SO4•10H2O | 59.57 |
| H2SO4 | 4.08 |

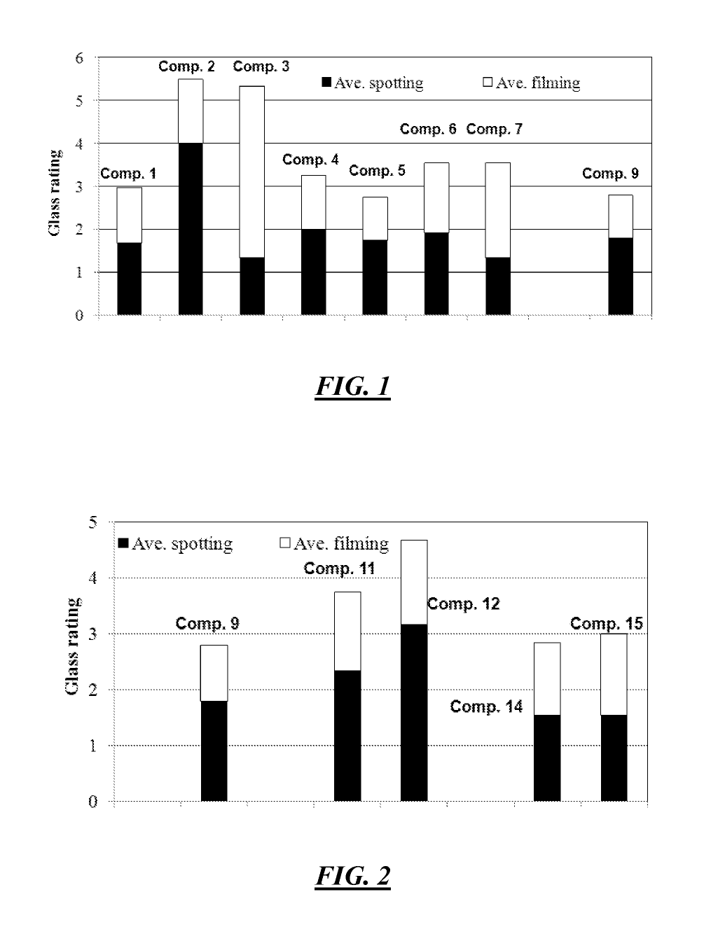

The results of the Rinse Efficiency Evaluations are set forth in FIGS. 1-3.

Additional samples of the Compositions are evaluated to determine Stability of Enzyme performance. The Stability of Enzyme performance is evaluated according to the following method.

1. Calibrate a Konica Minolta reflectometer according to the manufacturer's instructions.

2. Measure the “Lab” color space coordinates in three places on each pre-soiled dish monitors (as purchased from TestMaterials Inc.) using the reflectometer.

3. Place one of each soiled dish monitor, evenly spaced, on both the top and bottom racks of the dishwasher. Use the stainless steel dish monitor holders to keep the monitors in place.

4. Add composition as indicated for the experiment into the dispensing cup.

5. Select the Normal wash cycle on dishwasher and run one cycle using a municipal water source.

6. After the dish monitors have dried completely, measure the “Lab” color space coordinates in 3 places on each monitor, as in step 2.

7. Calculate % clean for each point, according to the following equations.

dE=[(L_{(after wash)}−L_{(before wash)})²+(a_{(after wash)}−a_{(before wash)})²+(b_{(after wash)}−b_{(before wash)})² ]^{1/2}

% clean=100×dE/[((93.95−L_{(before wash)})²+(−1−a_{(before wash)})²+(2.56−b_{(before wash)})₂)^{1/2}]

8. The % clean results are reported at time=0 and are representative of the activity of the enzymes present.

9. A sample of the detergent is than aged at 35 days at 37 C.

10. After aging the detergent sample the composition is tested again to observe the effect of how heated aging affected the enzyme performance (as measured by the reduction of % clean of the monitor).

The results of the Stability of Enzyme performance are set forth in FIG. 4.

Each of the Compositions 1-15 are described in greater detail below.

| Composition 1 | % Active | Wt % | Active % | Amt (G) | % Of H₂O |
|---|---|---|---|---|---|
| Solvent | | 20.00 | | 20.00 | 0.0% |
| Chelant 1 | 40.00 | 17.00 | 6.800 | 17.00 | 10.2% |
| Polymer | 50.00 | 5.00 | 2.500 | 5.00 | 2.5% |
| Ionic Liquid | | 56.70 | | 56.70 | |
| Enzyme 1 | | 1.00 | | 1.00 | 1.0% |
| Enzyme 2 | | 0.30 | | 0.30 | 0.3% |
| Sum | | 100.00 | | 100.00 | 14.0% |
| Batch Size (G) | 100.00 | | | | |

Solvent 1 is Glycerin.

Chelant 1 is Trilon M Liquid which is commercially available from BASF and is an aqueous solution of the trisodium salt of methylglycinediacetic acid (Na₃MGDA).

Polymer is Sokalan PA 25 CL PN which is commercially available from BASF and is a low molecular weight polyacrylic acid, partially neutralized as a sodium salt.

Ionic Liquid is Tris(2-hydroxyethyl)methylammonium methylsulfate commercially available from BASF under the tradename Basionics™ FS 01.

Enzyme 1 is a liquid protease commercially available from Novozymes under the tradename Savinase Ultra 16 L.

Enzyme 2 is a liquid amylase commercially available from Novozymes under the tradename Stainzyme Plus 12L.

| Composition 2 | % Active | Wt % | Active % | Amt (G) | % Of H₂O |
|---|---|---|---|---|---|
| Solvent | | 20.00 | | 20.00 | 0.0% |
| Chelant 1 | 40.00 | 17.00 | 6.800 | 17.00 | 10.2% |
| Polymer | 95.00 | 2.60 | 2.470 | 2.60 | 0.1% |
| Ionic Liquid | | 56.70 | | 56.70 | |
| Enzyme 1 | | 1.00 | | 1.00 | 1.0% |
| Enzyme 2 | | 0.30 | | 0.30 | 0.3% |
| Water | | 2.40 | | 2.40 | 2.4% |
| Sum | | 100.00 | | 100.00 | 14.0% |
| Batch Size (G) | 100.00 | | | | |

Solvent is as described above.

Chelant 1 is as described above.

Polymer is as described above.

Ionic Liquid is as described above.

Enzyme 1 is as described above.

Enzyme 2 is as described above.

| Composition 3 | % Active | Wt % | Active % | Amt (G) | % Of H₂O |
|---|---|---|---|---|---|
| Solvent | | 20.00 | | 20.00 | 0.0% |
| Chelant 1 | 40.00 | 17.00 | 6.800 | 17.00 | 10.2% |
| Polymer | 50.00 | 5.00 | 2.500 | 5.00 | 2.5% |
| Ionic Liquid | | 56.70 | | 56.70 | |
| Water | | 1.30 | | 1.30 | 1.3% |
| Sum | | 100.00 | | 100.00 | 14.0% |
| Batch Size (G) | 100.00 | | | | |

Solvent is as described above.

Chelant 1 is as described above.

Polymer is as described above.

Ionic Liquid is as described above.

| (Comparative) | | | | | |
|---|---|---|---|---|---|
| Composition 4 | % Active | Wt % | Active % | Amt (G) | % Of H₂O |
| Solvent | | 20.00 | | 20.00 | |
| Chelant 1 | 40.00 | 17.00 | 6.800 | 17.00 | 10.2% |
| Polymer | 50.00 | 5.00 | 2.500 | 5.00 | 2.5% |
| Water | | 56.70 | | 56.70 | 56.7% |
| Enzyme 1 | | 1.00 | | 1.00 | 1.0% |
| Enzyme 2 | | 0.30 | | 0.30 | 0.3% |
| Sum | | 100.00 | | 100.00 | 70.7% |
| Batch Size (G) | 100.00 | | | | |

Solvent is as described above.

Chelant 1 is as described above.

Polymer is as described above.

Ionic Liquid is as described above.

Enzyme 1 is as described above.

Enzyme 2 is as described above.

There is no ionic liquid present in (Comparative) Composition 4.

| Composition 5 | % Active | Wt % | Active % | Amt (G) | % Of H₂O |
|---|---|---|---|---|---|
| Solvent | | 20.00 | | 20.00 | 0.0% |
| Chelant 1 | 40.00 | 17.00 | 6.800 | 17.00 | 10.2% |
| Polymer | 50.00 | 5.00 | 2.500 | 5.00 | 2.5% |
| Ionic Liquid | | 50.70 | | 50.70 | |
| Enzyme 1 | | 1.00 | | 1.00 | 1.0% |
| Enzyme 2 | | 0.30 | | 0.30 | 0.3% |
| Surfactant | | 6.00 | | 6.00 | 3.0% |
| Sum | | 100.00 | | 100.00 | 17.0% |
| Batch Size (G) | 100.00 | | | | |

Solvent is as described above.

Chelant 1 is as described above.

Polymer is as described above.

Ionic Liquid is as described above.

Enzyme 1 is as described above.

Enzyme 2 is as described above.

| Composition 6 | % Active | Wt % | Active % | Amt (G) | % Of H₂O |
|---|---|---|---|---|---|
| Solvent 2 | | 20.00 | | 20.00 | 0.0% |
| Chelant 1 | 40.00 | 17.00 | 6.800 | 17.00 | 10.2% |
| Polymer | 50.00 | 5.00 | 2.500 | 5.00 | 2.5% |
| Ionic Liquid | | 56.70 | | 56.70 | |
| Enzyme 1 | | 1.00 | | 1.00 | 1.0% |
| Enzyme 2 | | 0.30 | | 0.30 | 0.3% |
| Sum | | 100.00 | | 100.00 | 14.0% |
| Batch Size (G) | 100.00 | | | | |

Solvent 2 is propylene glycol.

Chelant 1 is as described above.

Polymer is as described above.

Ionic Liquid is as described above.

Enzyme 1 is as described above.

Enzyme 2 is as described above.

| Composition 7 | % Active | Wt % | Active % | Amt (G) | % Of H₂O |
|---|---|---|---|---|---|
| Solvent | | 20.00 | | 20.00 | 0.0% |
| Chelant 1 | 40.00 | 17.00 | 6.800 | 17.00 | 10.2% |
| Polymer | 50.00 | 5.00 | 2.500 | 5.00 | 2.5% |
| Ionic Liquid | | 55.20 | | 55.20 | |
| Enzyme 1 | | 1.00 | | 1.00 | 1.0% |
| Enzyme 2 | | 0.30 | | 0.30 | 0.3% |
| Polymer | 22.00 | 1.50 | | 1.50 | 1.2% |
| Additive | | | | | |
| Sum | | 100.00 | | 100.00 | 15.2% |
| Batch Size (G) | 100.00 | | | | |

Solvent is as described above.

Chelant 1 is as described above.

Polymer is as described above.

Ionic Liquid is as described above.

Enzyme 1 is as described above.

Enzyme 2 is as described above.

The Polymer Additive is used to reduce spotting and filming build up on dish, glass, and flatware and has an INCI name of polyquaternium-95. The Polymer Additive is a free-radically initiated graft polymerization of: (A) 45 to 90% by weight of maltodextrin; (B) 10 to 40% by weight of 3 -trimethylammonium propylmethacrylamide chloride and/or dimethyldiallylammonium chloride; and (C) 5 to 30% by weight of acrylic acid; wherein all weight percentages are based on the total weight of (A), (B) and (C).

| Composition 8 | % Active | Wt % | Active % | Amt (G) | % Of H₂O |
|---|---|---|---|---|---|
| Solvent | | 20.00 | | 40.00 | 0.0% |
| Chelant 1 | 40.00 | 17.00 | 6.800 | 34.00 | 9.5% |
| Polymer | 50.00 | 5.00 | 2.500 | 10.00 | 2.5% |
| Ionic Liquid | | 55.20 | | 110.40 | |
| Enzyme 1 | | 2.50 | | 5.00 | 2.5% |
| Enzyme 2 | | 0.30 | | 0.60 | 0.3% |
| Sum | | 100.00 | | 200.00 | 14.8% |
| Batch Size (G) | 200.00 | | | | |

Solvent is as described above.

Chelant 1 is as described above.

Polymer is as described above.

Ionic Liquid is as described above.

Enzyme 1 is as described above.

Enzyme 2 is as described above.

| Composition 9 | % Active | Wt % | Active % | Amt (G) | % Of H₂O |
|---|---|---|---|---|---|
| Solvent | | 20.00 | | 40.00 | 0.0% |
| Chelant 1 | 40.00 | 30.00 | 12.000 | 60.00 | 16.8% |
| Polymer | 50.00 | 5.00 | 2.500 | 10.00 | 2.5% |
| Ionic Liquid | | 42.20 | | 84.40 | |
| Enzyme 1 | | 2.50 | | 5.00 | 2.5% |
| Enzyme 2 | | 0.30 | | 0.60 | 0.3% |
| Sum | | 100.00 | | 200.00 | 22.1% |
| Batch Size (G) | 200.00 | | | | |

Solvent is as described above.

Chelant 1 is as described above.

Polymer is as described above.

Ionic Liquid is as described above.

Enzyme 1 is as described above.

Enzyme 2 is as described above.

| Composition | | | | | |
|---|---|---|---|---|---|
| 10 | % Active | Wt % | Active % | Amt (G) | % Of H₂O |
| Solvent | | 20.00 | | 40.00 | 0.0% |
| Chelant 1 | 40.00 | 8.40 | 3.360 | 16.80 | 4.7% |
| Chelant 2 | 78.00 | 16.00 | 12.480 | 32.00 | |
| Polymer | 50.00 | 5.00 | 2.500 | 10.00 | 2.5% |
| Ionic Liquid | | 47.80 | | 95.60 | |
| Enzyme 1 | | 2.50 | | 5.00 | 2.5% |
| Enzyme 2 | | 0.30 | | 0.60 | 0.3% |
| Sum | | 100.00 | | 200.00 | 10.0% |
| Batch Size (G) | 200.00 | | | | |

Solvent is as described above.

Chelant 1 is as described above.

Chelant 2 is Trilon M in solid form.

Polymer is as described above.

Ionic Liquid is as described above.

Enzyme 1 is as described above.

Enzyme 2 is as described above.

| Composition | | | | | |
|---|---|---|---|---|---|
| 11 | % Active | Wt % | Active % | Amt (G) | % Of H₂O |
| Solvent | | 20.00 | | 40.00 | 0.0% |
| Chelant 1 | 40.00 | 17.00 | 6.800 | 34.00 | 9.5% |
| Chelant 2 | 78.00 | 18.00 | 14.040 | 36.00 | |
| Polymer | 50.00 | 5.00 | 2.500 | 10.00 | 2.5% |
| Ionic Liquid | | 37.20 | | 74.40 | |
| Enzyme 1 | | 2.50 | | 5.00 | 2.5% |
| Enzyme 2 | | 0.30 | | 0.60 | 0.3% |
| Sum | | 100.00 | | 200.00 | 14.8% |
| Batch Size (G) | 200.00 | | | | |

Solvent is as described above.

Chelant 1 is as described above.

Chelant 2 is as described above.

Polymer is as described above.

Ionic Liquid is as described above.

Enzyme 1 is as described above.

Enzyme 2 is as described above.

| Composition | | | | | |
|---|---|---|---|---|---|
| 12 | % Active | Wt % | Active % | Amt (G) | % Of H₂O |
| Solvent | | 20.00 | | 40.00 | 0.0% |
| Chelant 1 | 40.00 | 30.00 | 12.000 | 60.00 | 16.8% |
| Chelant 2 | 78.00 | 21.00 | 16.380 | 42.00 | |
| Polymer | 50.00 | 5.00 | 2.500 | 10.00 | 2.5% |
| Ionic Liquid | | 21.20 | | 42.40 | |
| Enzyme 1 | | 2.50 | | 5.00 | 2.5% |
| Enzyme 2 | | 0.30 | | 0.60 | 0.3% |
| Sum | | 100.00 | | 200.00 | 22.1% |
| Batch Size (G) | 200.00 | | | | |

Solvent is as described above.

Chelant 1 is as described above.

Chelant 2 is as described above.

Polymer is as described above.

Ionic Liquid is as described above.

Enzyme 1 is as described above.

Enzyme 2 is as described above.

| Composition | | | | | |
|---|---|---|---|---|---|
| 13 | % Active | Wt % | Active % | Amt (G) | % Of H₂O |
| Solvent | | 20.00 | | 40.00 | 0.0% |
| Chelant 1 | 40.00 | 8.40 | 3.360 | 16.80 | 4.7% |
| Chelant 2 | 78.00 | 8.00 | 6.240 | 16.00 | |
| Polymer | 50.00 | 5.00 | 2.500 | 10.00 | 2.5% |
| Ionic Liquid | | 55.80 | | 111.60 | |
| Enzyme 1 | | 2.50 | | 5.00 | 2.5% |
| Enzyme 2 | | 0.30 | | 0.60 | 0.3% |
| Sum | | 100.00 | | 200.00 | 10.0% |
| Batch Size (G) | 200.00 | | | | |

Solvent is as described above.

Chelant 1 is as described above.

Chelant 2 is as described above.

Polymer is as described above.

Ionic Liquid is as described above.

Enzyme 1 is as described above.

Enzyme 2 is as described above.

| Composition | | | | | |
|---|---|---|---|---|---|
| 14 | % Active | Wt % | Active % | Amt (G) | % Of H₂O |
| Solvent | | 20.00 | | 40.00 | 0.0% |
| Chelant 1 | 40.00 | 17.00 | 6.800 | 34.00 | 9.5% |
| Chelant 2 | 78.00 | 9.00 | 7.020 | 18.00 | |
| Polymer | 50.00 | 5.00 | 2.500 | 10.00 | 2.5% |
| Ionic Liquid | | 46.20 | | 92.40 | |
| Enzyme 1 | | 2.50 | | 5.00 | 2.5% |
| Enzyme 2 | | 0.30 | | 0.60 | 0.3% |
| Sum | | 100.00 | | 200.00 | 14.8% |
| Batch Size (G) | 200.00 | | | | |

Solvent is as described above.

Chelant 1 is as described above.

Chelant 2 is as described above.

Polymer is as described above.

Ionic Liquid is as described above.

Enzyme 1 is as described above.

Enzyme 2 is as described above.

| Composition | | | | | |
|---|---|---|---|---|---|
| 15 | % Active | Wt % | Active % | Amt (G) | % Of H₂O |
| Solvent | | 20.00 | | 40.00 | 0.0% |
| Chelant 1 | 40.00 | 30.00 | 12.000 | 60.00 | 16.8% |
| Chelant 2 | 78.00 | 11.00 | 8.580 | 22.00 | |
| Polymer | 50.00 | 5.00 | 2.500 | 10.00 | 2.5% |
| Ionic Liquid | | 31.20 | | 62.40 | |
| Enzyme 1 | | 2.50 | | 5.00 | 2.5% |
| Enzyme 2 | | 0.30 | | 0.60 | 0.3% |
| Sum | | 100.00 | | 200.00 | 22.1% |
| Batch Size (G) | 200.00 | | | | |

Solvent is as described above.

Chelant 1 is as described above.

Chelant 2 is as described above.

Polymer is as described above.

Ionic Liquid is as described above.

Enzyme 1 is as described above.

Enzyme 2 is as described above.

The Comparative Compositions, as set forth in FIG. 4, are: 7th Generation Pac; Cascade Platinum; Finish Gel Pacs; Finish Powerball Quantum; Smarty Dish Detergent; Smarty Dish Detergent Plus; and Up and Up.

The results described above and set forth in FIGS. 1-3 and 4 demonstrate the following.

### FIGS. 1 & 2 Results:

The extent of spotting and filming is being measured in these Figures on a score of 1 to 5. A score of 1 means the glassware is completely free of spots and film and a score of 5 means the glass is completely covered with spots and film. The data shows that a variety of compositions, notably Compositions 1, 4, 5, 6, 7, 9, 14 and 15, have excellent spotting and filming performance. Composition 2 includes an AMPS polymer which has lower performance, but is still considered acceptable. Composition 3 is missing enzymes.

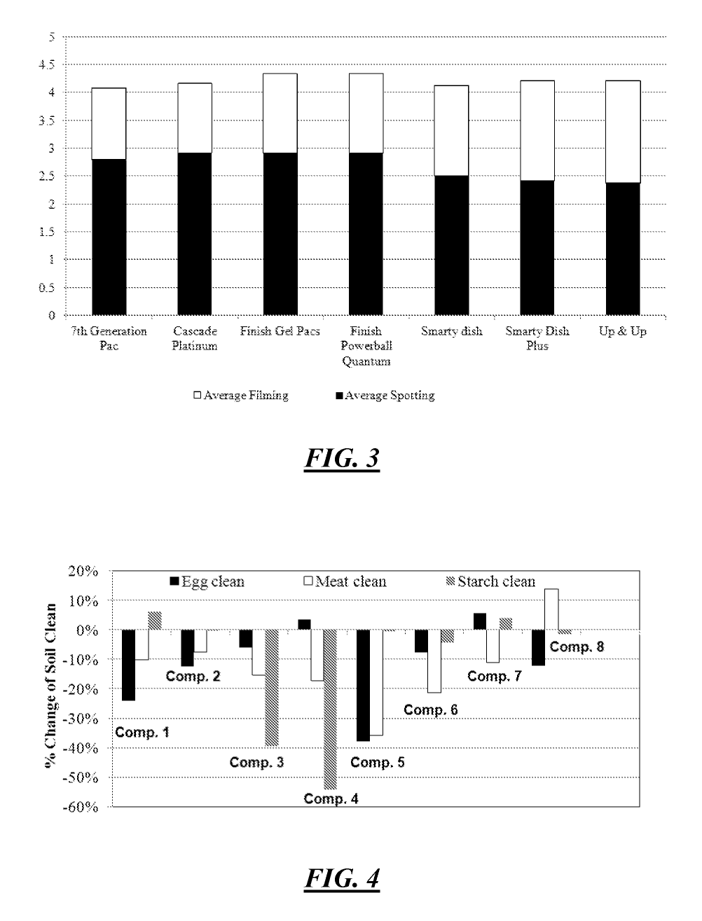

### FIG. 3 Results:

The extent of spotting of and filming of commercially available detergents is evaluated in FIG. 3. More specifically, the testing conditions are designed to differentiate between detergents under the “worst-case” scenario of extremely hard water and high soil load and do not necessarily reflect a typical home consumer experience. A spotting score less than or equal to 3 and a filming score less than or equal to 2 is considered in the art to be adequate for a typical consumer using softened municipal water with lightly soiled dishware. The bar graph of FIG. 3 is stacked so, for example, 7th Generation Pac has a spotting score of 2.75 and a filming score of 1.3. The commonly accepted convention in the art is that any score with a difference greater than 0.25 is perceivable to the consumer. Compositions 1, 3, 4, 5, 6, 7, 9, 11, 14, and 15 all show spotting scores less than 3 and compositions 1, 2, 4, 5, 6, 7, 9, 11, 12, 14, 15 all show filming scores less than 2. Ultimately products typically need to be evaluated by consumers for their acceptance and products with higher spotting and filming in this test may perform differently under usual home use conditions. The aforementioned composition are at parity with or better than the commercially available products.

### FIG. 4 Results:

The stability of enzymes in the Compositions of this disclosure are evaluated by measuring their ability to remove egg, meat, and starch soils at time zero (fresh sample) and after 35 days at 37 C. Protease cleans the egg and meat and Amylase cleans the starch. The % loss of cleaning performance can be correlated to degradation of enzyme. Composition 4 does not include an ionic liquid and significant loss of enzyme activity is observed. When comparing Composition 4 to Composition 1, the only difference is the presence of the ionic liquid in Composition 1 vs. Composition 4.

### Disintegration of Water-Soluble Films:

### Compositions 16-19:

Ten pouches (i.e., water soluble film pouches) are produced using each of Monosol PVA pouches M8630, M8310, and M8900. These pouches are disposed about Compositions 16-19.

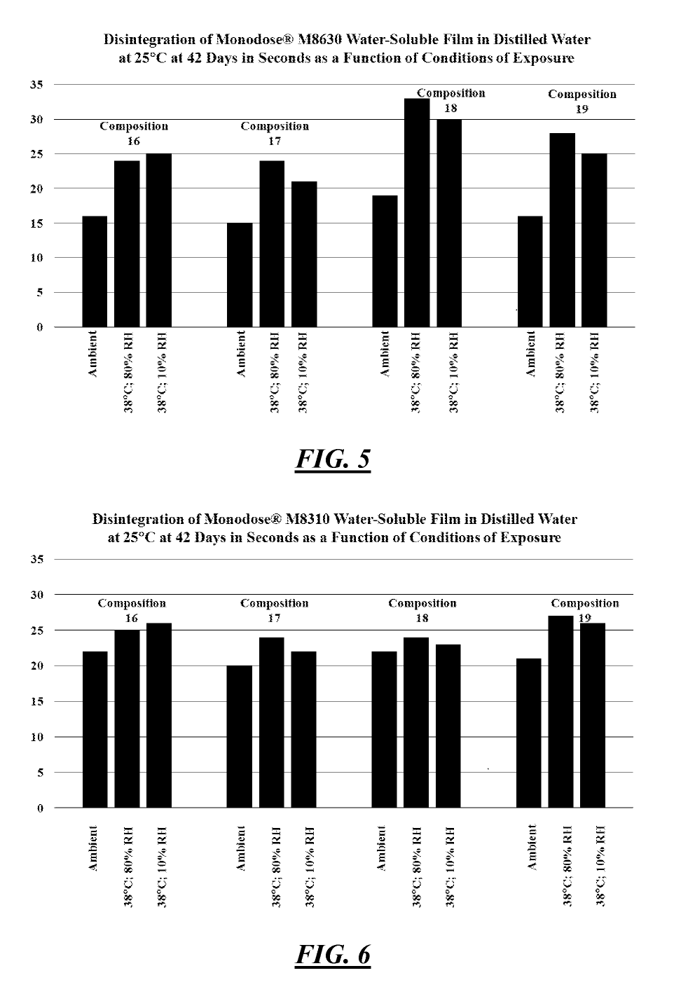

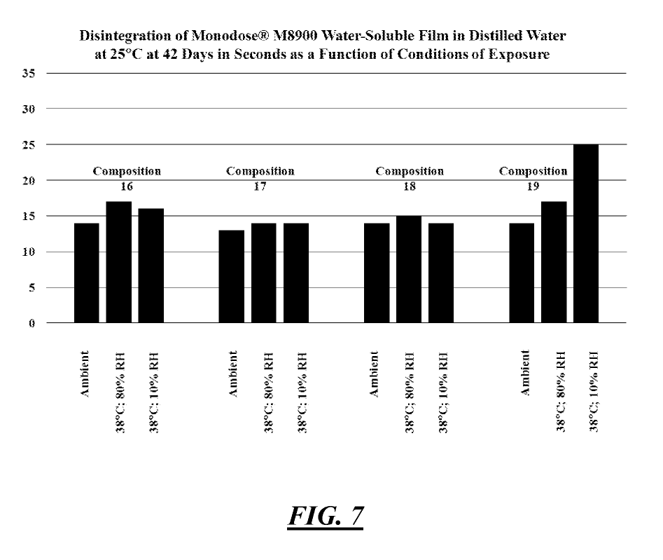

The pouches are divided into three groups (two groups of four pouches, one group of two). Each group is collectively inserted into labeled HDPE jars and capped prior to subjecting to ambient temperature and humidity; 38 C, 80% RH; or 38 C, 10% RH test environments. Samples from the 38 C, 10% RH environment are analyzed only following 42 days of product exposure. All candidates have a nominal thickness of 76 microns (3 mils). Film solubility tests are conducted according to MSTM (MonoSol Standard Test Method) 205 in distilled water at 25 C. The results set forth in FIGS. 5-7 illustrate an overall elevation of time required to initiate disintegration and complete solubility following product exposure within all test environments. Each of the Compositions 16-19 are described in greater detail below, wherein all values are weight percent unless otherwise indicated.

| | Compo- | Compo- | Compo- | Compo- |
|---|---|---|---|---|
| | sition | sition | sition | sition |
| | 16 | 17 | 18 | 19 |
| Solvent 1 | 20.00 | 30.00 | 20.00 | 20.00 |
| Chelant 1 | 17.00 | 17.00 | 8.50 | 17.00 |
| Polymer | 5.00 | 5.00 | 5.00 | 5.00 |
| Ionic Liquid | 54.70 | 44.70 | 63.20 | 46.70 |
| Polymer 2 | 0.50 | 0.50 | 0.50 | 0.50 |
| Water, wt % | 2.80 | 2.80 | 2.80 | 10.80 |
| Sum, wt % | 100.00 | 100.00 | 100.00 | 100.00 |
| Theoretical water | 15.2 | 15.2 | 10.4 | 23.2 |
| content, % | | | | |
| pH | 8.48 | 8.46 | 6.23 | 8.54 |
| Viscosity, cP | 175.0 | 173.0 | 261.9 | 59.0 |
| (Spindle LV2 @ 60 rpm) | | | | |
| Density, g/mL | 1.3095 | 1.3003 | 1.3135 | 1.2785 |

Solvent 1 is Glycerin.

Chelant 1 is Trilon M Liquid which is commercially available from BASF and is an aqueous solution of the trisodium salt of methylglycinediacetic acid (Na3MGDA).

Polymer is Sokalan PA 25 CL PN which is commercially available from BASF and is a low molecular weight polyacrylic acid, partially neutralized as a sodium salt.

Ionic Liquid is Tris(2-hydroxyethyl)methylammonium methylsulfate commercially available from BASF under the tradename Basionics™ FS 01.

Polymer 2 is Polyquart EcoClean that is commercially available from BASF and is an amphoteric modified starch that acts as a natural-based, biodegradable, hydrophilization polymer.

All values and ranges of values between and including the aforementioned values are hereby expressly contemplated in various non-limiting embodiments. One or more of the values described above may vary by -5%, -10%, -15%, -20%, -25%, etc. so long as the variance remains within the scope of the disclosure. Unexpected results may be obtained from each member of a Markush group independent from all other members. Each member may be relied upon individually and or in combination and provides adequate support for specific embodiments within the scope of the appended claims. The subject matter of all combinations of independent and dependent claims, both singly and multiply dependent, is herein expressly contemplated. The disclosure is illustrative including words of description rather than of limitation. Many modifications and variations of the present disclosure are possible in light of the above teachings, and the disclosure may be practiced otherwise than as specifically described herein.

1. An encapsulated cleaning composition comprising:
A. a core cleaning composition comprising:
an ionic liquid,
water present in an amount of from 10 to 50 parts by weight per 100 parts by weight of said core cleaning composition, and
at least one of a chelant, an enzyme, and a surfactant; and
B. a water-soluble film disposed about said core cleaning composition;
wherein said water-soluble film has a disintegration time of less than 90 seconds as determined at 40° C. using distilled water according to MSTM 205 when disposed about said core cleaning composition; and
wherein said water-soluble film remains stable for 6 months at 25° C. when disposed about said core cleaning composition.

2. The encapsulated cleaning composition of claim 1 wherein the stability of the water-soluble film is such that no amount of core cleaning composition leaks through the water-soluble film for a period of 6 months at 25° C.

3. The encapsulated cleaning composition of claim 1 wherein said water-soluble film is selected from the group consisting of polyvinyl alcohol, polyvinyl acetate, polyvinyl acetate that is 88-98% hydrolyzed, gelatin, and combinations thereof.

4. The encapsulated cleaning composition of claim 1 wherein said core cleaning composition consists essentially of said ionic liquid, said water and said chelant.

5. The encapsulated cleaning composition of claim 1 wherein said core cleaning composition consists essentially of said ionic liquid, said water and said enzyme.

6. The encapsulated cleaning composition of claim 1 wherein said core cleaning composition consists essentially of said ionic liquid, said water and said surfactant.

7. The encapsulated cleaning composition of claim 1 wherein said core cleaning composition consists essentially of said ionic liquid, said water, said chelant, said enzyme, and said surfactant.

8. The encapsulated cleaning composition of claim 1 wherein said core cleaning composition consists essentially of said ionic liquid, said water, said chelant, said enzyme, and said surfactant.

9. The encapsulated cleaning composition of claim 1 wherein said core cleaning composition further comprises a solvent.

10. The encapsulated cleaning composition of claim 1 wherein said core cleaning composition further comprises a polymer.

11. The encapsulated cleaning composition of claim 1 wherein said ionic liquid is tris(2-hydroxyethyl)methyl-ammonium methyl sulfate.

12. The encapsulated cleaning composition of claim 1 wherein said chelant is methylglycinediacetic acid.

13. The encapsulated cleaning composition of claim 1 wherein said enzyme is selected from the group consisting of amylase, protease, and a combination thereof.

14. The encapsulated cleaning composition of claim 1 wherein said surfactant is selected from the group consisting of alcohol alkoxylates, alkyl/aryl ether sulfates, alkyl/aryl sulfonates, alkyl/aryl sulfates, alkyl betaines, C₁₂-C₁₈ dialkyl quaternary ammonium salts, ethyleneoxide/propylene oxide block copolymers, and combinations thereof.

15. The encapsulated cleaning composition of claim 9 wherein said solvent is selected from the group consisting of propylene glycol, ethylene glycol, butylene glycol, and mono or di ethers thereof, glyme, diglyme, triglyme, polyethylene glycol having a weight average molecular weight up to 600 g/mol, 1,3-propanediol, 1,4-butanediol, glycerine, and combinations thereof.

16. (canceled)

17. A method of forming an encapsulated cleaning composition comprising a core cleaning composition comprising an ionic liquid, water present in an amount of from 10 to 50 parts by weight per 100 parts by weight of the core cleaning composition, and at least one of a chelant, an enzyme, and a surfactant; and a water-soluble film disposed about the core cleaning composition; wherein the water-soluble film has a disintegration time of less than 90 seconds as determined at 40° C. using distilled water according to MSTM 205 when disposed about the core cleaning composition; and wherein the water-soluble film remains stable for 6 months at 25° C. when disposed about the core cleaning composition, said method comprising the steps of:
providing the core cleaning composition; and
disposing the water-soluble film about the core cleaning composition.

18. An encapsulated cleaning composition comprising:
A. a core cleaning composition comprising:
an ionic liquid,
water present in an amount of from 10 to 20 parts by weight per 100 parts by weight of said core cleaning composition,
a chelant, and
two or more enzymes; and
B. a water-soluble film disposed about said core cleaning composition;
wherein said water-soluble film has a disintegration time of less than 90 seconds as determined at 40° C. using distilled water according to MSTM 205 when disposed about said core cleaning composition; and
wherein said water-soluble film remains stable for 6 months at 25° C. when disposed about said core cleaning composition.

19. The encapsulated cleaning composition of claim 18 wherein said water-soluble film is selected from the group consisting of polyvinyl alcohol, polyvinyl acetate, polyvinyl acetate that is 88-98% hydrolyzed, gelatin, and combinations thereof.

20. The encapsulated cleaning composition of claim 18 wherein said chelant is methylglycinediacetic acid, said two or more enzymes comprise amylase and protease, and said ionic liquid is tris(2-hydroxyethyl)methyl-ammonium methylsulfate.
